(19) United States
(12) Patent Application Publication
(10) Pub. No.: US 2026/0084420 A1
(43) Pub. Date: Mar. 26, 2026

(54) PRINT TIMING SIGNAL GENERATION METHOD, PRINTING APPARATUS, AND NON-TRANSITORY COMPUTER-READABLE RECORDING MEDIUM RECORDING PRINT TIMING SIGNAL GENERATION PROGRAM

(71) Applicant: SCREEN Holdings Co., Ltd., Kyoto (JP)

(72) Inventors: Manato TOMITA, Kyoto-shi (JP); Toshimitsu HAMAGISHI, Kyoto-shi (JP)

(21) Appl. No.: 19/284,932

(22) Filed: Jul. 30, 2025

(30) Foreign Application Priority Data
Sep. 24, 2024 (JP) 2024-164843

(51) Int. Cl. B41J 2/045

(52) U.S. Cl. CPC B41J 2/04573; B41J 2/04586

(57) ABSTRACT

By counting the number of internal clocks, the length of each unit period (a period from a rising edge of an encoder pulse to the next rising edge) is measured. A reference signal is generated based on the length of a first unit period (unit period one preceding). A print timing signal is generated based on the reference signal and a multiplication setting value representing a relationship between the frequency of the print timing signal and the frequency of the reference signal. A position deviation amount is calculated based on the length of the first unit period and the length of a second unit period (unit period two preceding), and a cumulative position deviation amount, obtained by accumulating the position deviation amount, is calculated. When the cumulative position deviation amount falls outside a position deviation allowable range, the multiplication setting value is adjusted.

### CROSS-REFERENCE TO RELATED APPLICATIONS

This application claims priority to Japanese Patent Application No. 2024-164843 filed on Sep. 24, 2024 entitled “Print Timing Signal Generation Method, Printing Apparatus, and Print Timing Signal Generation Program”, the content of which is incorporated herein by reference.

### BACKGROUND OF THE INVENTION

### Field of the Invention

The present invention relates to a printing apparatus that performs printing by ejecting ink from a print head, and more particularly to a method for generating a print timing signal that defines a timing at which ink is ejected from a print head of a printing apparatus.

### Description of Related Art

An inkjet printing apparatus that performs printing by ejecting ink onto a printing medium by heat or pressure is widely known. In an inkjet printing apparatus that performs high-speed printing, long band-shaped printing paper (continuous paper) called roll paper is typically adopted as a printing medium. The long belt-shaped printing paper is conveyed by a conveyance mechanism including a conveyance roller and the like, and printing is performed by ejecting ink from a print head onto the conveyed printing paper.

When printing is performed on the long belt-shaped printing paper, first, the conveyance speed (the distance that the printing paper is conveyed per unit time by the conveyance mechanism) of the printing paper gradually increases from a state where the apparatus is stopped. That is, the conveyance speed is accelerated at the start of printing. When the conveyance speed reaches a predetermined speed, printing is performed with the conveyance speed maintained at a constant speed. Thereafter, at the end of printing, the conveyance speed gradually decreases from the predetermined speed until the apparatus stops. That is, the conveyance speed is decelerated at the end of printing. Some inkjet printing apparatuses provide a plurality of speeds as settable conveyance speeds (printing speeds). Generally, in such an inkjet printing apparatus, in normal cases, printing is performed with the conveyance speed set to the maximum speed among the plurality of prepared speeds. However, during a period in which printing is performed with the conveyance speed set to the maximum speed, deceleration of the conveyance speed may be required for various reasons. For example, in an inkjet printing apparatus that provides “high speed” and “low speed” as settable conveyance speeds, when the conveyance speed is required to be decreased during a period in which printing is performed with the conveyance speed set to high speed, the conveyance speed is changed from high speed to low speed. Then, printing is performed with the conveyance speed maintained at low speed. Thereafter, when the state in which printing needs to be performed with the conveyance speed set to low speed is resolved, the conveyance speed is changed from low speed to high speed, and printing is performed with the conveyance speed maintained at high speed.

As described above, during the operation of the inkjet printing apparatus, the conveyance speed is accelerated and decelerated. Some inkjet printing apparatuses are capable of performing printing not only during a period in which the conveyance speed is maintained at a constant speed but also during a period in which the conveyance speed is changing (i.e., during a period in which the conveyance speed is being accelerated or decelerated). Note that printing performed during a period in which the conveyance speed is changing is called “acceleration/deceleration printing”.

Generally, in the inkjet printing apparatus, a pulse signal that defines an ejection timing of ink from a print head is provided to a head drive circuit that drives the print head so that the ink is ejected from the print head onto printing paper at an appropriate timing. In the present specification, the pulse signal is referred to as a “print timing signal”. The print timing signal is generated based on an encoder signal outputted from an encoder attached to a rotary shaft of a conveyance roller constituting a conveyance mechanism. Thus, when the conveyance speed is high, the print timing signal is generated so that ink is ejected from the print head at relatively short time intervals, and when the conveyance speed is low, the print timing signal is generated so that ink is ejected from the print head at relatively long time intervals.

Here, an example of a conventional method for generating the print timing signal PT will be described with reference to FIG. 22. In this example, two-phase signals (phase A signal ENC_A and phase B signal ENC_B) constitute an encoder signal, and the duty ratio of the two-phase signals is one-half. The print timing signal PT is a pulse signal, and the head drive circuit drives the print head so that ink is ejected from the print head at a rising edge of the pulse signal. The print timing signal PT is generated depending on the cycle length of the encoder signal. For example, the print timing signal PT in period TA1 is generated based on the length of period A1 (the period from the rising edge of the phase A signal ENC_A to the next rising edge), and the print timing signal PT in period TB4 is generated based on the length of period B4 (the period from the falling edge of the phase B signal ENC_B to the next falling edge). In this manner, with respect to FIG. 22, when X is any character string, the print timing signal PT in period TX is generated based on the length of period X. Note that the length of each period X is obtained by counting the number of internal clocks generated during the above period X.

The head drive circuit drives the print head based on the print timing signal PT generated as described above, whereby ink is ejected from the print head depending on the conveyance speed of the printing paper. Thus, a good print image is formed on printing paper regardless of the conveyance speed at the time of printing. However, while acceleration/deceleration printing described above is performed, the conveyance speed at the time of generation of the print timing signal PT is different from the conveyance speed at the time of actual ejection of ink from the print head, and thus the ink ejected from the print head lands at a position offset from the desired landing position on the printing paper. Due to the disorder of the ink landing position as above, a good print image cannot be obtained.

Japanese Laid-Open Patent Publication No. 2007-118425 discloses an invention of a timing pulse generation device capable of outputting an appropriate print timing signal (“jet timing signal” in Japanese Laid-Open Patent Publication No. 2007-118425) even during acceleration/deceleration of printing paper. According to that invention, by subtracting “the difference between the previous encoder cycle and an encoder cycle before that” from the previous encoder cycle, the current encoder cycle is predicted (i.e., a predicted cycle is obtained). Then, a preliminary timing signal is outputted by counting pulses of a delay signal generated by performing a frequency division process on the predicted cycle, and the print timing signal is generated based on the preliminary timing signal.

However, according to the invention disclosed in Japanese Laid-Open Patent Publication No. 2007-118425, it is assumed that the conveyance speed changes at a constant rate when acceleration/deceleration printing is performed. Thus, if the change in the conveyance speed when acceleration/deceleration printing is performed is not constant (i.e., if there is a change in the degree of acceleration or deceleration), the print timing signal cannot be generated so that ink is ejected from the print head at an appropriate timing. Accordingly, an ink landing position deviation occurs, and a good print image cannot be obtained.

### SUMMARY OF THE INVENTION

Therefore, an object of the present invention is to realize a printing apparatus capable of reducing an ink landing position deviation when acceleration/deceleration printing is performed, as compared to the related art.

One aspect of the present invention is directed to a print timing signal generation method for generating a print timing signal that defines a timing at which ink is ejected from a print head in a printing apparatus including a print head configured to eject ink onto a printing medium, a moving mechanism configured to relatively move a positional relationship between the print head and the printing medium, an encoder configured to output a pulse at a cycle corresponding to a moving speed that is a speed at which the moving mechanism relatively moves the positional relationship, and an internal clock generating circuit configured to generate an internal clock at a constant cycle, the print timing signal generation method including:
measuring a length of each of unit periods by counting a number of internal clocks, the unit periods each being a period from a rising edge of a pulse outputted from the encoder to a next rising edge, or a period from a falling edge of a pulse outputted from the encoder to a next falling edge;
generating, based on a length of a first unit period that is a unit period one preceding, a reference signal corresponding to a signal obtained by multiplying a frequency of the print timing signal;
generating the print timing signal based on the reference signal and a multiplication setting value that is a setting value of a multiplication factor representing a relationship between the frequency of the print timing signal and a frequency of the reference signal;
calculating, based on the length of the first unit period and a length of a second unit period that is a unit period two preceding, a position deviation amount caused by a difference between the moving speed in the second unit period and the moving speed in the first unit period;
calculating a cumulative position deviation amount by accumulating the position deviation amount; and
adjusting the multiplication setting value based on a result of comparing the cumulative position deviation amount with a predetermined threshold,
wherein in the generating the print timing signal, after the print timing signal one preceding is generated, the print timing signal is generated when a number of times the reference signal is generated becomes equal to the multiplication setting value.

According to such a configuration, with the generation cycle of the pulse outputted from the encoder regarded as a unit period, based on the length of a second unit period that is a unit period two preceding and the length of a first unit period that is a unit period one preceding, a position deviation amount caused by a difference between the printing speed (the moving speed at which the moving mechanism relatively moves the positional relationship between the print head and the printing medium) in the second unit period and the printing speed in the first unit period is calculated. In addition, a cumulative position deviation amount, obtained by accumulating the position deviation amount, is calculated. Then, based on the result of comparing the cumulative position deviation amount with the threshold, the setting value (multiplication setting value) of the multiplication factor representing the relationship between the frequency of the reference signal used to generate the print timing signal and the frequency of the print timing signal is adjusted. The print timing signal is generated when the number of times the reference signal is generated becomes equal to the multiplication setting value after the print timing signal one preceding is generated. Therefore, by appropriately setting the threshold so that the multiplication setting value is suitably adjusted, the print timing signal can be generated at a suitable timing for reducing the magnitude of the position deviation. From the above, the printing apparatus capable of reducing an ink landing position deviation when acceleration/deceleration printing is performed, as compared to the related art, is realized. Furthermore, the reduction in ink landing position deviation decreases the necessity of reprinting, suppressing wasteful consumption of printing media and ink. In this way, it is possible to contribute to the achievement of the sustainable development goals (SDGs).

Another aspect of the present invention is directed to a printing apparatus including:
a print head configured to eject ink onto a printing medium;
a moving mechanism configured to relatively move a positional relationship between the print head and the printing medium;
an encoder configured to output a pulse at a cycle corresponding to a moving speed that is a speed at which the moving mechanism relatively moves the positional relationship;
an internal clock generating circuit configured to generate an internal clock at a constant cycle;
an encoder cycle length measuring circuit configured to measure a length of each of unit periods by counting a number of internal clocks, the unit periods each being a period from a rising edge of a pulse outputted from the encoder to a next rising edge, or a period from a falling edge of a pulse outputted from the encoder to a next falling edge;
a print timing signal generating circuit configured to generate a print timing signal that defines a timing at which ink is ejected from the print head; and
a print timing signal correcting circuit configured to correct a timing at which the print timing signal is generated,
wherein
the print timing signal generating circuit includes
a reference signal generation counter configured to generate, based on a length of a first unit period that is a unit period one preceding, a reference signal corresponding to a signal obtained by multiplying a frequency of the print timing signal, by counting a number of the internal clocks, and
a print timing signal generation counter configured to generate, by counting a number of reference signals generated by the reference signal generation counter, the print timing signal when a number of times the reference signal is generated becomes equal to a multiplication setting value that is a setting value of a multiplication factor representing a relationship between the frequency of the print timing signal and a frequency of the reference signal, after the print timing signal one preceding is generated, and
the print timing signal correcting circuit includes
a position deviation amount updating circuit configured to calculate, based on the length of the first unit period and a length of a second unit period that is a unit period two preceding, a position deviation amount caused by a difference between the moving speed in the second unit period and the moving speed in the first unit period, and calculate a cumulative position deviation amount by accumulating the position deviation amount, and
an adjustment circuit configured to adjust the multiplication setting value referred to by the print timing signal generation counter, based on a result of comparing the cumulative position deviation amount with a predetermined threshold.

Still another aspect of the present invention is directed to a non-transitory computer-readable recording medium recording a print timing signal generation program for generating a print timing signal that defines a timing at which ink is ejected from a print head in a printing apparatus including a print head configured to eject ink onto a printing medium, a moving mechanism configured to relatively move a positional relationship between the print head and the printing medium, an encoder configured to output a pulse at a cycle corresponding to a moving speed that is a speed at which the moving mechanism relatively moves the positional relationship, and an internal clock generating circuit configured to generate an internal clock at a constant cycle,
the print timing signal generation program causing a computer included in the printing apparatus to execute:
measuring a length of each of unit periods by counting a number of internal clocks, the unit periods each being a period from a rising edge of a pulse outputted from the encoder to a next rising edge, or a period from a falling edge of a pulse outputted from the encoder to a next falling edge;
generating, based on a length of a first unit period that is a unit period one preceding, a reference signal corresponding to a signal obtained by multiplying a frequency of the print timing signal;
generating the print timing signal based on the reference signal and a multiplication setting value that is a setting value of a multiplication factor representing a relationship between the frequency of the print timing signal and a frequency of the reference signal;
calculating, based on the length of the first unit period and a length of a second unit period that is a unit period two preceding, a position deviation amount caused by a difference between the moving speed in the second unit period and the moving speed in the first unit period;
calculating a cumulative position deviation amount by accumulating the position deviation amount; and
adjusting the multiplication setting value based on a result of comparing the cumulative position deviation amount with a predetermined threshold,
wherein in the generating the print timing signal, after the print timing signal one preceding is generated, the print timing signal is generated when a number of times the reference signal is generated becomes equal to the multiplication setting value.

These and other objects, features, modes, and advantageous effects of the present invention will become more apparent from the following detailed description of the present invention with reference to the accompanying drawings.

### BRIEF DESCRIPTION OF THE DRAWINGS

FIG. 1 is a schematic diagram showing a configuration example of an inkjet printing apparatus according to an embodiment of the present invention;

FIG. 2 is a plan view showing a configuration example of a recording unit in the embodiment;

FIG. 3 is a view for explaining an arrangement of nozzles in a print head in the embodiment;

FIG. 4 is a block diagram showing a hardware configuration of a print control device in the embodiment;

FIG. 5 is a timing chart for explaining calculation of a position deviation amount in a case where a print timing signal is generated based on a one-phase encoder signal in the embodiment;

FIG. 6 is a timing chart for explaining calculation of a position deviation amount in a case where a print timing signal is generated based on two-phase encoder signals in the embodiment;

FIG. 7 is a timing chart for explaining reference signal in the embodiment;

FIG. 8 is a view for explaining a distance corresponding to one cycle of a print timing signal in the embodiment;

FIG. 9 is a timing chart for explaining generation of a print timing signal in the embodiment;

FIG. 10 is a block diagram showing a functional configuration of a controller in the print control device in the embodiment;

FIG. 11 is a block diagram showing a detailed configuration of a print timing signal generating circuit in the embodiment;

FIG. 12 is a block diagram showing a detailed configuration of a print timing signal correcting circuit in the embodiment;

FIG. 13 is a diagram showing a relationship between a first threshold, a second threshold, and a position deviation allowable range in the embodiment;

FIG. 14 is a flowchart for explaining outlines of processes related to generation of a print timing signal in the embodiment;

FIG. 15 is a flowchart showing a detailed procedure of a process performed by an encoder cycle length measuring circuit in the embodiment;

FIG. 16 is a flowchart showing a detailed procedure of processes performed by the print timing signal generating circuit in the embodiment;

FIG. 17 is a flowchart showing a detailed procedure of processes performed by the print timing signal correcting circuit in the embodiment;

FIGS. 18A, 18B, 18C, 18D, and 18E are timing charts for explaining a specific example of generation of the print timing signal when a conveyance speed is maintained at a constant speed in the embodiment;

FIGS. 19A, 19B, 19C, 19D, 19E, 19F, 19G, 19H, 19I, 19J, and 19K are timing charts for explaining a specific example of generation of the print timing signal during the acceleration of the conveyance speed in the embodiment;

FIGS. 20A, 20B, 20C, 20D, 20E, 20F, 20G, 20H, 20I, 20J, 20K, 20L, and 20M are timing charts for explaining a specific example of generation of the print timing signal during the deceleration of the conveyance speed in the embodiment;

FIG. 21 is a schematic diagram showing a configuration example of an inkjet printing apparatus in a third modification of the embodiment; and

FIG. 22 is a timing chart for explaining an example of a conventional method for generating a print timing signal.

### DETAILED DESCRIPTION OF PREFERRED EMBODIMENT

An embodiment of the present invention will be described with reference to the accompanying drawings.

### 1. Configuration of Inkjet Printing Apparatus

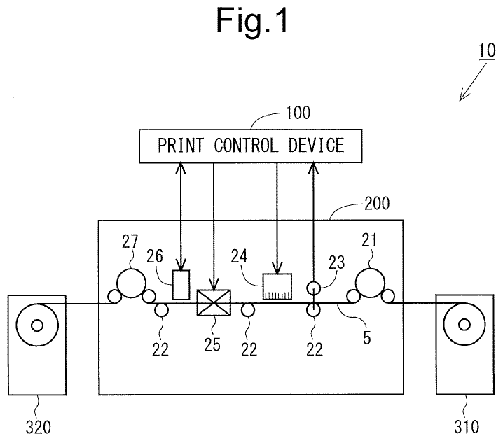

FIG. 1 is a schematic diagram showing a configuration example of an inkjet printing apparatus 10 according to one embodiment of the present invention. The inkjet printing apparatus 10 includes a printer body 200, a print control device 100 that controls the operation of the printer body 200, a paper feeding unit 310 that supplies printing paper (in this example, roll paper) 5 as a printing medium to the printer body 200, and a paper winding unit 320 that winds the printing paper 5 after printing in a roll shape. The inkjet printing apparatus 10 outputs a print image on the printing paper 5 based on print data that is data after a rasterization process transmitted via a network such as a local-area network (LAN), without using a printing plate. Note that the present invention is also applicable to a case where a printing medium other than the printing paper is used (e.g., a film is used).

The printer body 200 includes a first drive roller 21 for conveying the printing paper 5 to the inside, a plurality of conveyance rollers 22 for conveying the printing paper 5 inside the printer body 200, a recording unit 24 for recording a print image on the printing paper 5, a drying mechanism 25 for drying the printing paper 5 on which the print image is recorded, an imaging device (e.g., a contact image sensor) 26 for capturing the print image recorded on the printing paper 5 by the recording unit 24, and a second drive roller 27 for outputting the printing paper 5 from the inside of the printer body 200. An encoder 23 is attached to a rotary shaft of one of the plurality of conveyance rollers 22. Note that the conveyance roller 22, to which the encoder 23 is attached, is located upstream of the recording unit 24 in the conveyance direction of the printing paper 5. The imaging data obtained by the imaging device 26 capturing the print image is transmitted to the print control device 100, and the print control device 100 performs a process of detecting, for example, a defective nozzle using the imaging data.

Note that the paper feeding unit 310, the first drive roller 21, the plurality of conveyance rollers 22, the second drive roller 27, and the paper winding unit 320 constitute a conveyance mechanism that conveys the printing paper 5. In the present embodiment, a moving mechanism that relatively moves a positional relationship between the print head 241, which will be described later, and the printing paper 5 is realized by the conveyance mechanism. Further, a conveyance speed (printing speed) at which the conveyance mechanism conveys the printing paper 5 corresponds to a moving speed at which the positional relationship between the print head 241 and the printing paper 5 is relatively moved.

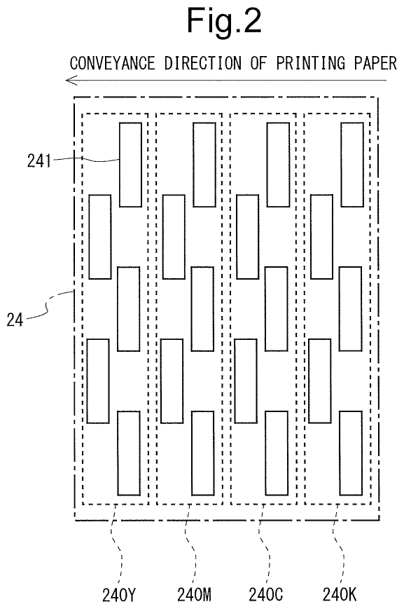

FIG. 2 is a plan view showing a configuration example of the recording unit 24. The recording unit 24 includes a K-color head unit 240K that ejects K color (black) ink, a C-color head unit 240C that ejects C color (cyan) ink, an M-color head unit 240M that ejects M color (magenta) ink, and a Y-color head unit 240Y that ejects Y color (yellow) ink. Each head unit 240 includes a plurality of print heads 241 arranged in a staggered manner. Each print head 241 includes many nozzles (not shown in FIG. 2) that eject ink. Each nozzle of the print head 241 included in the K-color head unit 240K ejects K-color ink, each nozzle of the print head 241 included in the C-color head unit 240C ejects C-color ink, each nozzle of the print head 241 included in the M-color head unit 240M ejects M-color ink, and each nozzle of the print head 241 included in the Y-color head unit 240Y ejects Y-color ink. The timing at which the ink is ejected from each nozzle is controlled by the print timing signal.

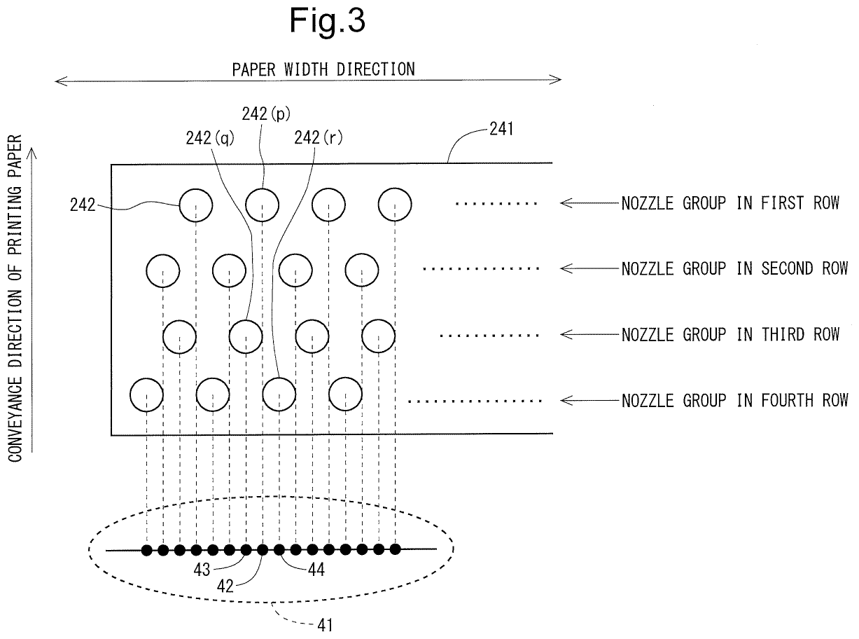

FIG. 3 is a diagram for explaining the arrangement of the nozzles 242 in the print head 241. Typically, the print head 241 includes a plurality of rows of nozzle groups, each of the nozzle groups including a plurality of nozzles 242 arranged side by side in the paper width direction. In the example shown in FIG. 3, four rows of nozzle groups are included in the print head 241. The portion denoted by reference numeral 41 in FIG. 3 schematically shows landing positions, on the printing paper 5, of ink ejected from respective nozzles 242. The plurality of nozzles 242 in the print head 241 are arranged so that the landing positions of ink ejected from the nozzles 242 included in the nozzle group in the first row, the landing positions of ink ejected from the nozzles 242 included in the nozzle group in the second row, the landing positions of ink ejected from the nozzles 242 included in the nozzle group in the third row, and the landing positions of ink ejected from the nozzles 242 included in the nozzle group in the fourth row are different positions. For example, the landing position of ink ejected from each nozzle 242 included in the nozzle group in the first row is a position between the landing position of ink ejected from the nozzle 242 included in the nozzle group in the third row and the landing position of ink ejected from the nozzle 242 included in the nozzle group in the fourth row. In the example shown in FIG. 3, the landing position 42 of ink ejected from the nozzle denoted by reference numeral 242(p) is a position between the landing position 43 of ink ejected from the nozzle denoted by reference numeral 242(q) and the landing position 44 of ink ejected from the nozzle denoted by reference numeral 242(r).

Note that the configurations shown in FIGS. 1 to 3 are merely examples, and specific configurations of the inkjet printing apparatus 10, the recording unit 24, and the print head 241 are not particularly limited.

### 2. Hardware Configuration of Print Control Device

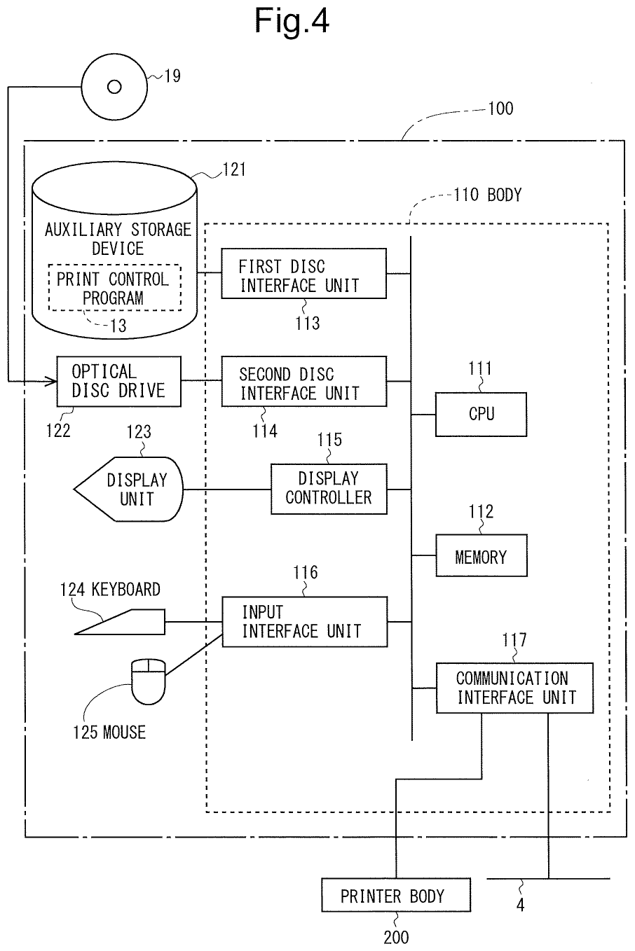

FIG. 4 is a block diagram showing a hardware configuration of the print control device 100. As shown in FIG. 4, the print control device 100 includes a body 110, an auxiliary storage device 121, an optical disc drive 122, a display unit 123, a keyboard 124, a mouse 125, and the like. The body 110 includes a central processing unit (CPU) 111, a memory 112, a first disc interface unit 113, a second disc interface unit 114, a display controller 115, an input interface unit 116, and a communication interface unit 117. The CPU 111, the memory 112, the first disc interface unit 113, the second disc interface unit 114, the display controller 115, the input interface unit 116, and the communication interface unit 117 are connected to each other via a system bus. The auxiliary storage device 121 is connected to the first disc interface unit 113. The optical disc drive 122 is connected to the second disc interface unit 114. The display unit (display device) 123 is connected to the display controller 115. The keyboard 124 and the mouse 125 are connected to the input interface unit 116. The printer body 200 is connected to the communication interface via a communication cable. The communication interface unit 117 is connected to a LAN 4. The auxiliary storage device 121 is a magnetic disk device or the like. An optical disc 19 as a computer-readable recording medium, such as a compact disc read-only memory (CD-ROM) or a digital versatile disc (DVD)-ROM, is inserted into the optical disc drive 122. The display unit 123 is a liquid crystal display or the like. The display unit 123 is used to display information desired by an operator. The keyboard 124 and the mouse 125 are used by the operator to input instructions to the print control device 100.

The auxiliary storage device 121 stores a print control program (a program for controlling the execution of a printing process by the printer body 200) 13. The CPU 111 reads the print control program 13 stored in the auxiliary storage device 121 into the memory 112 and executes the program to implement various functions of the print control device 100. The memory 112 includes a random access memory (RAM) and a read only memory (ROM). The memory 112 functions as a work area for the CPU 111 to execute the print control program 13 stored in the auxiliary storage device 121. Note that the print control program 13 is provided by being stored in the computer-readable recording medium (non-transitory recording medium). That is, for example, a user purchases the optical disc 19 as the recording medium of the print control program 13, inserts the optical disc 19 into the optical disc drive 122, reads the print control program 13 from the optical disc 19, and installs the print control program in the auxiliary storage device 121.

Although only one CPU 111 is provided as a processor in the print control device 100 in the example illustrated in FIG. 4, the present invention is not limited thereto. A configuration using a plurality of processors, such as a configuration using a plurality of CPUs, can also be adopted. As the processor, in addition to the CPU 111, a micro processing unit (MPU), a graphics processing unit (GPU), a digital signal processor (DSP), or the like can also be adopted. A combination of a plurality of types of processors can also be used. Moreover, a configuration including a field-programmable gate array (FPGA) or an application specific integrated circuit (ASIC) can also be adopted.

### 3. Print Timing Signal Generation Method

Hereinafter, generation of a print timing signal in the present embodiment will be described. In the following description, the conveyance speed in each period means an average conveyance speed in each period.

### <3.1 Overview>

As described above, according to the conventional method, while acceleration/deceleration printing is performed, the conveyance speed at the time of generation of the print timing signal is different from the conveyance speed at the time of actual ejection of ink from the print head 241, and thus the ink ejected from the print head 241 lands on the printing paper 5 at a position offset from the desired landing position. That is, a position deviation occurs in the landing of ink on the printing paper 5.

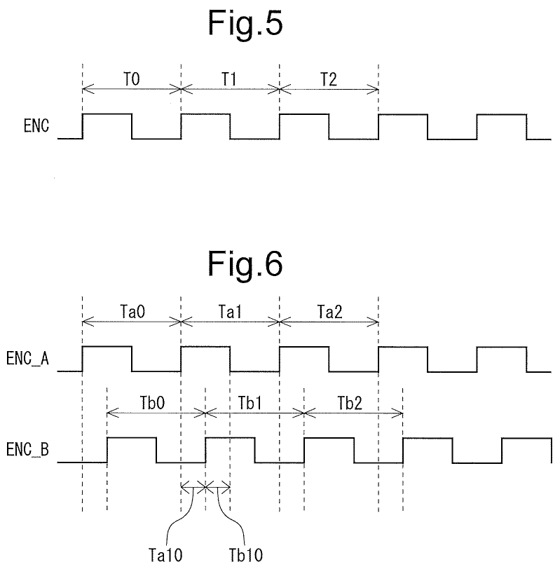

Regarding the position deviation, with reference to FIG. 5, attention is paid to a case where the print timing signal is generated based on a one-phase encoder signal ENC. Assuming that the conveyance speed in period T0 is V0 and the conveyance speed in period T1 is V1, the position deviation amount (distance of position deviation) Z(T1) that occurs in period T1 is calculated by the following equation (1)

$$Z ( T 1 ) = ( V 0 - V 1 ) \times T 1 \qquad ( 1 )$$

Assuming that the diameter of the conveyance roller 22, to which the encoder 23 is attached, is D, and the number of times of pulses outputted from the encoder 23 during one rotation of the conveyance roller 22 is NP, the conveyance speed V0 in period TO is calculated by the following equation (2) (the same applies to the conveyance speed V1 in period T1).

$$V 0 = ( D \times Π / NP ) / T 0 \qquad ( 2 )$$

Next, with reference to FIG. 6, attention is paid to a case where the print timing signal is generated based on two-phase encoder signals (phase A signal ENC_A and phase B signal ENC_B). Assuming that the conveyance speed in period Ta0 is Va0 and the conveyance speed in period Ta1 is Va1, the position deviation amount Z (Ta10) generated in period Ta10 is calculated by the following equation (3). Assuming that the conveyance speed in period Tb0 is Vb0 and the conveyance speed in period Tb1 is Vb1, a position deviation amount Z(Tb10) generated in period Tb10 is calculated by the following equation (4).

$$Z ( Ta 10 ) = ( Va 0 - Va 1 ) \times Ta 10 \qquad ( 3 )$$

$$Z ( Tb 10 ) = ( VB 0 - Vb 1 ) \times Tb 10 \qquad ( 4 )$$

The absolute value of the amount of cumulative position deviation (hereinafter referred to as a “cumulative position deviation amount”) increases as the conveyance distance of the printing paper 5 increases. Therefore, in the present embodiment, the print timing signal is generated so that the cumulative position deviation amount is prevented from falling outside the predetermined position deviation allowable range.

Regarding the generation of the print timing signal, the inkjet printing apparatus 10 according to the present embodiment uses a signal obtained by multiplying the frequency of the print timing signal. Specifically, a print timing signal in a certain period is generated based on a signal obtained by multiplying the frequency of a print timing signal in a period immediately before the certain period. Therefore, hereinafter, a signal (pulse signal) obtained by multiplying the frequency of the print timing signal is referred to as a “reference signal”.

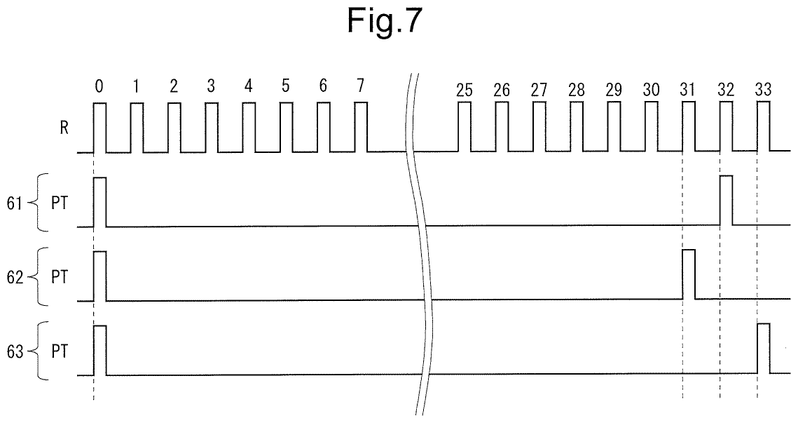

For example, reference signal obtained by multiplying the frequency of the print timing signal by 32 times is used. In this example, in the normal state, the print timing signal PT is generated every time the reference signal R is generated 32 times (in other words, a pulse as the print timing signal PT is outputted once for every 32 pulses as the reference signal R are outputted) (cf. the waveform of the print timing signal PT in the portion denoted by reference numeral 61 in FIG. 7) In the present embodiment, while acceleration/deceleration printing is performed, when the cumulative position deviation amount falls outside the position deviation allowable range, the timing for generating the print timing signal PT is corrected. Specifically, when the cumulative position deviation amount falls outside the position deviation allowable range during the acceleration of the conveyance speed, the print timing signal PT is generated at the timing when a thirty-first reference signal R is generated after the immediately preceding print timing signal PT is generated (cf. the waveform of the print timing signal PT in the portion denoted by reference numeral 62 in FIG. 7). When the cumulative position deviation amount falls outside the position deviation allowable range during the deceleration of the conveyance speed, the print timing signal PT is generated at the timing when a thirty-third reference signal R is generated after the immediately preceding print timing signal PT is generated (cf. the waveform of the print timing signal PT in the portion denoted by reference numeral 63 in FIG. 7). Even during the period in which acceleration/deceleration printing is performed, in the period in which the cumulative position deviation amount is maintained within the position deviation allowable range, the print timing signal PT is generated, as in the normal state, at the timing when a thirty-second reference signal R is generated after the generation of the immediately preceding print timing signal PT (cf. the waveform of the print timing signal PT in the portion denoted by reference numeral 61 in FIG. 7).

To realize such a method as described above, in the present embodiment, a multiplication factor representing a relationship between the frequency of the print timing signal PT and the frequency of the reference signal R is set. Hereinafter, the setting value of the multiplication factor is referred to as a “multiplication setting value”. In the above example, the initial value (reference value) of the multiplication setting value is 32.

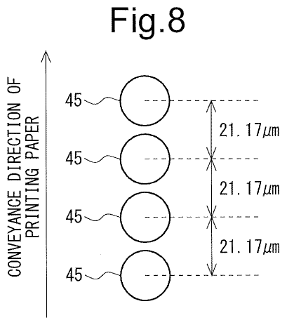

When the printing resolution is 1200 dpi, as shown in FIG. 8, the dot spacing (distance between the center of one of two adjacent dots 45 and the center of the other thereof) is 21.17 μm. In this case, a distance corresponding to one cycle of the print timing signal PT is 21.17 μm. Thus, if the reference signal R is a signal obtained by multiplying the frequency of the print timing signal PT by 32 times, the distance corresponding to one cycle of the reference signal R is 0.661 μm. In the present embodiment, the print timing signal PT is generated so that the absolute value of the cumulative position deviation amount is prevented from becoming greater than the distance corresponding to one cycle of the reference signal R.

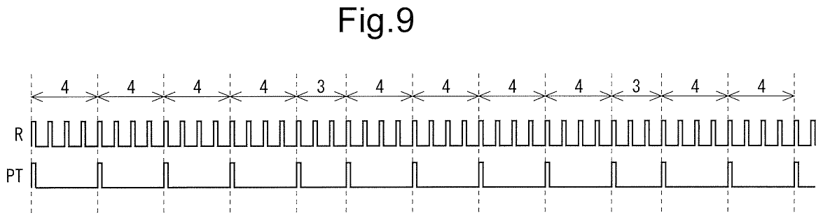

In the following description, for convenience of description, it is assumed that a signal obtained by multiplying the frequency of the print timing signal PT by four times is used as the reference signal R (i.e., the initial value of the multiplication setting value is 4). In this example, during the acceleration of the conveyance speed, when the cumulative position deviation amount is within the position deviation allowable range, the print timing signal PT is generated at the timing when a fourth reference signal R is generated after the immediately preceding print timing signal PT is generated, and when the cumulative position deviation amount falls outside the position deviation allowable range, the print timing signal PT is generated at the timing when a third reference signal R is generated after the immediately preceding print timing signal PT is generated (cf. FIG. 9). During the deceleration of the conveyance speed, when the cumulative position deviation amount is within the position deviation allowable range, the print timing signal PT is generated at the timing when the fourth reference signal R is generated after the immediately preceding print timing signal PT is generated, and when the cumulative position deviation amount falls outside the position deviation allowable range, the print timing signal PT is generated at the timing when a fifth reference signal R is generated after the immediately preceding print timing signal PT is generated.

### <3.2 Functional Configuration>

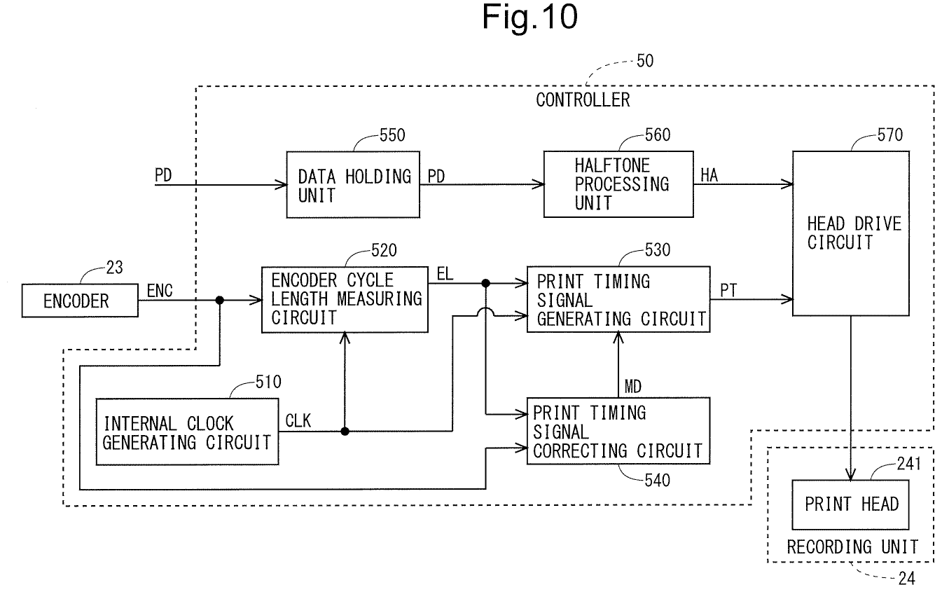

FIG. 10 is a block diagram showing a functional configuration of a controller 50 in the print control device 100. Note that FIG. 10 shows only components related to the control of the operation of the recording unit 24. The controller 50 includes an internal clock generating circuit 510, an encoder cycle length measuring circuit 520, a print timing signal generating circuit 530, a print timing signal correcting circuit 540, a data holding unit 550, a halftone processing unit 560, and a head drive circuit 570.

The internal clock generating circuit 510 generates an internal clock CLK at a constant cycle. Typically, the internal clock generating circuit 510 is included in the CPU 111 (cf. FIG. 4). The encoder cycle length measuring circuit 520 measures the cycle length of the encoder signal ENC by counting the number of internal clocks CLK generated in a period from a rising edge of a pulse as the encoder signal ENC outputted from the encoder 23 (hereinafter, this pulse is referred to as an “encoder pulse”) to the next rising edge. Hereinafter, the cycle length of the encoder signal ENC is referred to as an “encoder cycle length”, and the encoder cycle length is denoted by reference sign EL. In addition, hereinafter, a period from a rising edge of the encoder pulse to the next rising edge is referred to as a “unit period”. The length of each unit period is the encoder cycle length EL for each unit period. From the above, in other words, with a period from a rising edge of the encoder pulse to the next rising edge regarded as a unit period, the encoder cycle length measuring circuit 520 measures the length of each unit period by counting the number of internal clocks CLK. Note that a period from a falling edge of the encoder pulse to the next falling edge may be treated as the unit period.

The print timing signal generating circuit 530 generates the print timing signal PT based on the internal clock CLK and the encoder cycle length EL for each unit period. The print timing signal correcting circuit 540 corrects the timing at which the print timing signal PT is generated by the print timing signal generating circuit 530. In this regard, the print timing signal correcting circuit 540 calculates the position deviation amount based on the encoder cycle length EL for each unit period every time the encoder pulse rises. Then, the timing at which the print timing signal PT is generated is corrected based on the cumulative position deviation amount described above. Note that the timing at which the print timing signal PT is generated is corrected by changing the multiplication setting value described above. Thus, the print timing signal correcting circuit 540 provides the print timing signal generating circuit 530 with data (hereinafter referred to as “multiplication factor change instruction data”) MD instructing a change in the multiplication setting value. Therefore, the generation of the print timing signal PT in the print timing signal generating circuit 530 is performed considering the multiplication factor change instruction data MD. The print timing signal generating circuit 530 and the print timing signal correcting circuit 540 will be described in more detail later.

The data holding unit 550 temporarily holds print data PD transmitted via the network. The halftone processing unit 560 generates halftone image data HA that includes information indicating a dot size of ink corresponding to each pixel by performing halftone processing on the print data PD held in the data holding unit 550. As the dot size of the ink, for example, three-stage sizes (L-size, M-size, S-size) are prepared. Note that a specific method of the halftone processing is not particularly limited, and for example, a known method such as an error diffusion method or a dither method can be adopted.

The head drive circuit 570 drives each print head 241 constituting the recording unit 24 based on the halftone image data HA and the print timing signal PT. Thus, ink of an appropriate size is ejected at an appropriate timing from each of the plurality of nozzles 242 included in each print head 241, and a print image corresponding to the print data PD is formed on the printing paper 5.

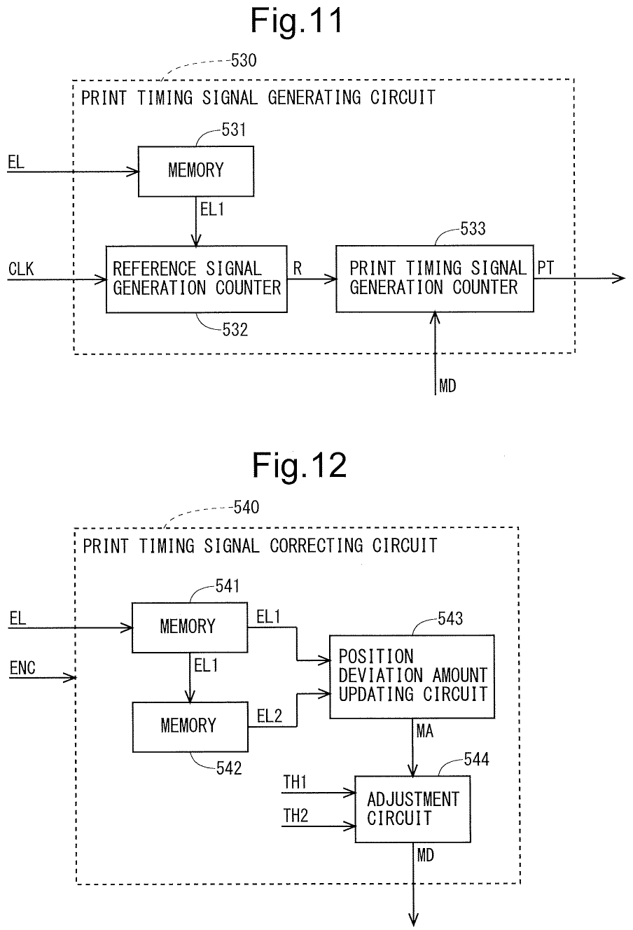

FIG. 11 is a block diagram showing a detailed configuration of the print timing signal generating circuit 530. The print timing signal generating circuit 530 includes a memory 531, a reference signal generation counter 532, and a print timing signal generation counter 533. Hereinafter, for convenience of description, the counter value of the reference signal generation counter 532 is referred to as a “first counter value”, and the counter value of the print timing signal generation counter 533 is referred to as a “second counter value”. The first counter value is denoted by reference numeral CNTa, and the second counter value is denoted by reference numeral CNTb. When each unit period is used as a reference, a unit period one preceding is referred to as a “first unit period”, and a unit period two preceding is referred to as a “second unit period”.

The encoder cycle length EL is provided from the encoder cycle length measuring circuit 520 to the print timing signal generating circuit 530 for each unit period (i.e., every time the encoder pulse rises). The memory 531 can hold the encoder cycle length EL for one unit period. Thus, the data of the encoder cycle length EL in the memory 531 is rewritten for each unit period. Therefore, in each unit period, the encoder cycle length EL for the first unit period is held in the memory 531. Hereinafter, the encoder cycle length for the first unit period is denoted by reference numeral EL1, and the encoder cycle length for the second unit period is denoted by reference numeral EL2.

The reference signal generation counter 532 generates the reference signal R based on the encoder cycle length EL1 held in the memory 531. In this regard, assuming that the number of times the reference signal R is to be generated in each unit period is P, the first counter value CNTa is incremented by P every time the internal clock CLK is generated. For example, in this regard, if the number of times the reference signal R is to be generated in each unit period is 6, 6 is added to the first counter value CNTa every time the internal clock CLK is generated. Then, when the first counter value CNTa becomes equal to or greater than the value of the encoder cycle length EL1, the value of the encoder cycle length EL1 is subtracted from the first counter value CNTa, and the reference signal R is generated. As above, the reference signal generation counter 532 generates the reference signal R based on the length of the first unit period by counting the number of internal clocks CLK.

The print timing signal generation counter 533 is provided with the reference signal R, generated by the counter 532, the reference signal generation and multiplication factor change instruction data MD described above. When the print timing signal PT is generated, the second counter value CNTb is set to 0, and thereafter, the second counter value CNTb is incremented by 1 every time the reference signal R is generated. Then, the print timing signal generation counter 533 generates the print timing signal PT at the timing when the second counter value CNTb becomes equal to the multiplication setting value described above. From the above, the print timing signal generation counter 533 generates the print timing signal PT when the number of times of generation of the reference signal R (the second counter value CNTb) becomes equal to the multiplication setting value after generating the print timing signal PT one preceding, by counting the number of reference signals R generated by the reference signal generation counter 532. In the present embodiment, the initial value of the multiplication setting value is 4. During a period in which the cumulative position deviation amount is maintained within the position deviation allowable range, the multiplication setting value is maintained at 4, and the print timing signal PT is generated when the second counter value CNTb becomes 4. When the cumulative position deviation amount falls outside the position deviation allowable range during the acceleration of the conveyance speed, the multiplication setting value becomes 3, and the print timing signal PT is generated when the second counter value CNTb becomes 3. When the cumulative position deviation amount falls outside the position deviation allowable range during the deceleration of the conveyance speed, the multiplication setting value becomes 5, and the print timing signal PT is generated when the second counter value CNTb becomes 5.

FIG. 12 is a block diagram showing a detailed configuration of the print timing signal correcting circuit 540. The print timing signal correcting circuit 540 includes a memory 541, a memory 542, a position deviation amount updating circuit 543, and an adjustment circuit 544.

Each of the memory 541 and the memory 542 can hold the encoder cycle length EL for one unit period. Specifically, in each unit period, the memory 541 holds the encoder cycle length EL1 for the first unit period, and the memory 542 holds the encoder cycle length EL2 for the second unit period. That is, the encoder cycle length EL1 for the first unit period, held in the memory 541, is held in the memory 542 as the encoder cycle length EL2 for the second unit period in the next unit period. Note that the writing of the data of the encoder cycle length EL to the memory 541 and the transfer of the data of the encoder cycle length EL from the memory 541 to the memory 542 are performed at the timing when the encoder pulse rises.

When the encoder pulse rises, the position deviation amount updating circuit 543 calculates the position deviation amount generated in the first unit period based on the encoder cycle length EL1 for the first unit period and the encoder cycle length EL2 for the second unit period. Then, the position deviation amount updating circuit 543 adds the calculated position deviation amount to a previous cumulative position deviation amount MA. The position deviation occurring in the first unit period is caused by a difference between the conveyance speed in the second unit period and the conveyance speed in the first unit period. From the above, the position deviation amount updating circuit 543 calculates the position deviation amount caused by the difference between the conveyance speed in the second unit period and the conveyance speed in the first unit period based on the length of the second unit period and the length of the first unit period, and calculates the cumulative position deviation amount MA by accumulating the position deviation amount.

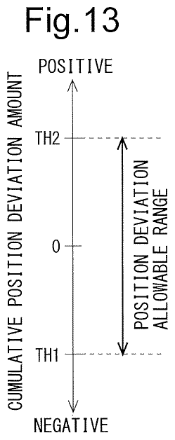

Based on a result of comparing the cumulative position deviation amount MA with two thresholds (first threshold TH1 and second threshold TH2) prepared in advance, the adjustment circuit 544 provides the print timing signal generation counter 533 in the print timing signal generating circuit 530 with the multiplication factor change instruction data MD instructing a change in the multiplication setting value. In this manner, the adjustment circuit 544 adjusts the multiplication setting value that is referred to by the print timing signal generation counter 533. As can be understood from the above equations (1), (3), and (4), the position deviation amount and the cumulative position deviation amount MA are negative values during the acceleration of the conveyance speed, and the position deviation amount and the cumulative position deviation amount MA are positive values during the deceleration of the conveyance speed. Therefore, two thresholds (first threshold TH1 and second threshold TH2) are prepared as described above. FIG. 13 shows a relationship between the first threshold TH1, the second threshold TH2, and the position deviation allowable range. As can be understood from FIG. 13, the first threshold TH1 is the lower limit value of the position deviation allowable range, and the second threshold TH2 is the upper limit value of the position deviation allowable range. In the present embodiment, when the cumulative position deviation amount MA becomes less than the first threshold TH1, the multiplication factor change instruction data MD instructing to subtract 1 from the multiplication setting value is provided from the adjustment circuit 544 to the print timing signal generation counter 533, and when the cumulative position deviation amount MA becomes greater than the second threshold TH2, the multiplication factor change instruction data MD instructing to add 1 to the multiplication setting value is provided from the adjustment circuit 544 to the print timing signal generation counter 533.

In the present embodiment, the first threshold TH1 and the second threshold TH2 are determined so that the absolute value of the first threshold TH1 is equal to the second threshold TH2, and so that the magnitude of one-half of the position deviation allowable range shown in FIG. 13 is equal to the distance corresponding to one cycle of the reference signal R. Therefore, the absolute value of the threshold (first threshold TH1 and second threshold TH2) is equal to the distance corresponding to one cycle of the reference signal R. Here, the distance corresponding to one cycle of the reference signal R is equal to a value obtained by dividing the distance corresponding to one cycle of the print timing signal PT (the distance corresponds to the dot spacing (cf. FIG. 8)) by the multiplication setting value before being adjusted by the adjustment circuit 544. That is, the absolute value of the threshold (first threshold TH1 and second threshold TH2) in the present embodiment is equal to a value obtained by dividing the spacing between the dots, formed on the printing paper 5 by ejection of ink from the print head 241, by the multiplication setting value before being adjusted by the adjustment circuit 544. By setting the threshold in this manner, if the initial value (reference value) of the multiplication setting value is M, the magnitude of the ink landing position deviation can be suppressed to about 1/M of the dot spacing at maximum.

Functions corresponding to the encoder cycle length measuring circuit 520, the print timing signal generating circuit 530, and the print timing signal correcting circuit 540 can also be realized by software. In this case, for example, the print timing signal generation program is included in the print control program 13 (cf. FIG. 4) as a subprogram. Then, the CPU 111 reads the print timing signal generation program into the memory 112 and executes the program, thereby implementing the functions corresponding to the encoder cycle length measuring circuit 520, the print timing signal generating circuit 530, and the print timing signal correcting circuit 540.

### <3.3. Process Procedure>

Hereinafter, a procedure of processes related to the generation of the print timing signal PT will be described.

### <3.3.1 General Procedure>

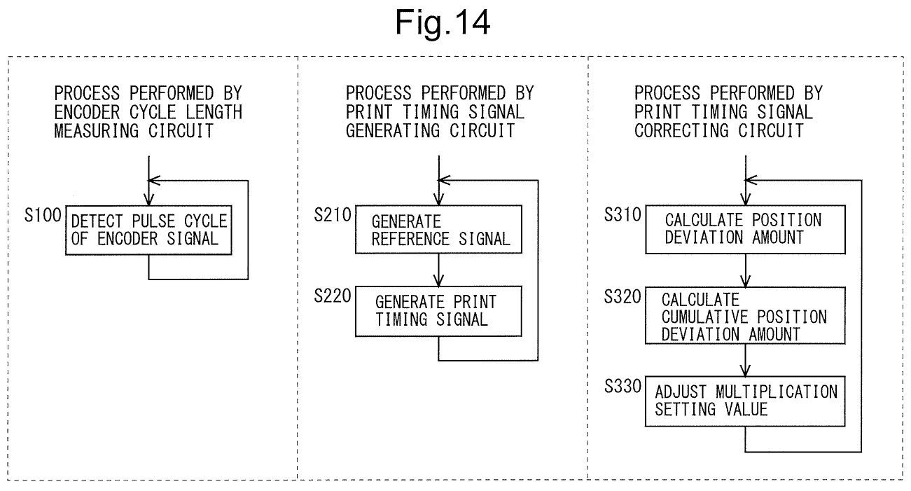

FIG. 14 is a flowchart for explaining outlines of processes related to the generation of the print timing signal PT. As can be understood from FIG. 14, the encoder cycle length measuring circuit 520, the print timing signal generating circuit 530, and the print timing signal correcting circuit 540 perform processes in parallel. As described above, the encoder cycle length measuring circuit 520 performs a process of measuring the encoder cycle length EL (in other words, a process of measuring the length of the unit period) (S100). The print timing signal generating circuit 530 performs a process of generating the reference signal R (step S210) and a process of generating the print timing signal PT from the reference signal R generated in step S210 (step S220). The print timing signal correcting circuit 540 performs a process of calculating the position deviation amount (step S310), a process of calculating the cumulative position deviation amount MA based on the position deviation amount calculated in step S310 (step S320), and a process of adjusting the multiplication setting value based on the cumulative position deviation amount MA calculated in step S320 (step S330).

In the present embodiment, the measuring the length of each of unit periods is realized by step S100 above, the generating the reference signal is realized by step S210 above, the generating the print timing signal is realized by step S220 above, the calculating the position deviation amount is realized by step S310 above, the calculating the cumulative position deviation amount is realized by step S320 above, and the adjusting the multiplication setting value is realized by step S330 above.

### <3.3.2 Detailed Procedure>

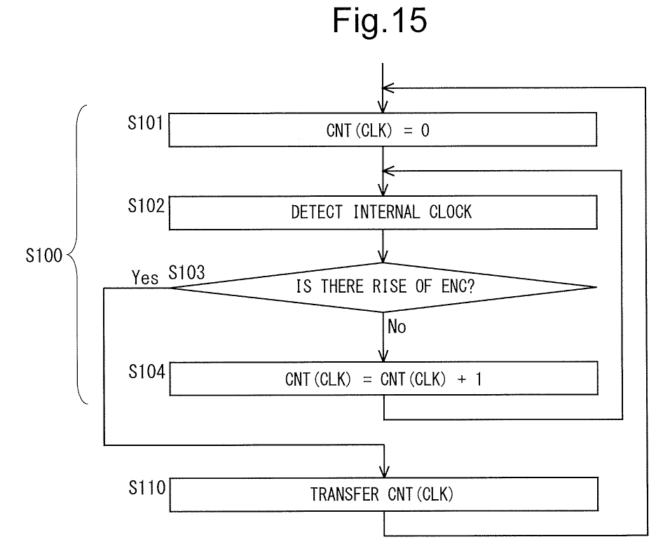

Hereinafter, a detailed procedure of the processes performed in each of the encoder cycle length measuring circuit 520, the print timing signal generating circuit 530, and the print timing signal correcting circuit 540 will be described. Since these processes are repeatedly performed throughout the period in which the inkjet printing apparatus 10 is operating, the illustration of the start and end of the process is omitted in each of the flowcharts shown in FIGS. 15 to 17.

### <3.3.2.1 Procedure of Process Performed by Encoder Cycle Length Measuring Circuit>

FIG. 15 is a flowchart showing a detailed procedure of the process performed by the encoder cycle length measuring circuit 520. In step S101, a value (hereinafter referred to as a “clock counter value”) CNT (CLK) of a counter that counts the number of internal clocks CLK is set to 0. Thereafter, when the internal clock CLK is detected (step S102), it is determined whether there is a rise of the encoder pulse (step S103). As a result, when there is a rise of the encoder pulse, the process proceeds to step S110, and when there is no rise of the encoder pulse, the process proceeds to step S104.

In step S104, 1 is added to the clock counter value CNT (CLK). Thereafter, the process returns to step S102.

In step S110, the clock counter value CNT (CLK) is transferred from the encoder cycle length measuring circuit 520 to the print timing signal generating circuit 530 and the print timing signal correcting circuit 540. The clock counter value CNT (CLK) is transferred every time the encoder pulse rises. Therefore, the clock counter value CNT (CLK) transferred from the encoder cycle length measuring circuit 520 to the print timing signal generating circuit 530 and the print timing signal correcting circuit 540 represents the encoder cycle length EL. That is, in step S110, substantially, the encoder cycle length EL is transferred from the encoder cycle length measuring circuit 520 to the print timing signal generating circuit 530 and the print timing signal correcting circuit 540. After completion of step S110, the process returns to step S101, and the clock counter value CNT (CLK) is set to 0.

As above, in step S100 (steps S101 to S104), the length of each unit period is measured by counting the number of the internal clocks CLK, with the period from the rising edge of the pulse outputted from the encoder 23 to the next rising edge regarded as the unit period.

### <3.3.2.2 Procedure of Processes Performed in Print Timing Signal Generating Circuit>

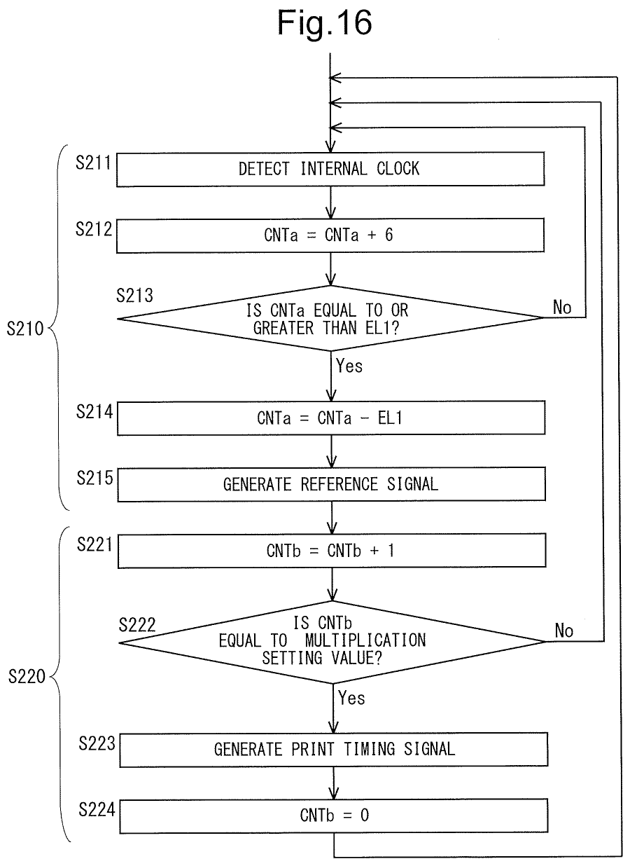

FIG. 16 is a flowchart showing a detailed procedure of the processes performed by the print timing signal generating circuit 530. As can be understood from FIG. 16, every time the internal clock CLK is detected (step S211), the processes from step S212 are performed.

In step S212, 6 is added to the first counter value CNTa in response to the detection of the internal clock CLK in step S211. Then, it is determined whether the first counter value CNTa is equal to or greater than a value indicating the length of the first unit period (the value corresponds to the encoder cycle length EL1 for the first unit period) (step S213). As a result, when the first counter value CNTa is equal to or greater than the value indicating the length of the first unit period, the process proceeds to step S214, and when the first counter value CNTa is less than the value indicating the length of the first unit period, the process returns to step S211.

In step S214, the value indicating the length of the first unit period (the encoder cycle length EL1 for the first unit period) is subtracted from the first counter value CNTa. Then, the reference signal R is generated (step S215). Thereafter, 1 is added to the second counter value CNTb (step S221). Then, it is determined whether the second counter value CNTb is equal to the multiplication setting value (step S222). As a result, when the second counter value CNTb is equal to the multiplication setting value, the process proceeds to step S223, and when the second counter value CNTb is not equal to the multiplication setting value (that is, when the second counter value CNTb is less than the multiplication setting value), the process returns to step S211.

In step S223, the print timing signal PT is generated. Thereafter, the second counter value CNTb is set to 0 (step S224), and the process returns to step S211.

As above, in step S210 (steps S211 to S215), the reference signal R corresponding to the signal obtained by multiplying the frequency of the print timing signal PT is generated based on the length of the first unit period, which is the unit period one preceding. In step S220 (steps S221 to S224), after the print timing signal PT one preceding is generated, the print timing signal PT is generated when the number of times the reference signal R is generated becomes equal to the multiplication setting value. Assuming that the number of times the reference signal R is to be generated in each unit period is P (in the above example, P=6), in step S210 (steps S211 to S215), P is added to the first counter value CNTa every time the internal clock CLK is generated by the internal clock generating circuit 510, and when the first counter value CNTa becomes equal to or greater than the value corresponding to the length of the first unit period, the value corresponding to the length of the first unit period is subtracted from the first counter value CNTa and the reference signal R is generated. In step S220 (steps S221 to S224), 1 is added to the second counter value CNTb every time the reference signal R is generated in step S210, and when the second counter value CNTb becomes equal to the multiplication setting value, the second counter value CNTb is set to 0 and the print timing signal PT is generated.

### <3.3.2.3 Procedure of Processes Performed by Print Timing Signal Correcting Circuit>

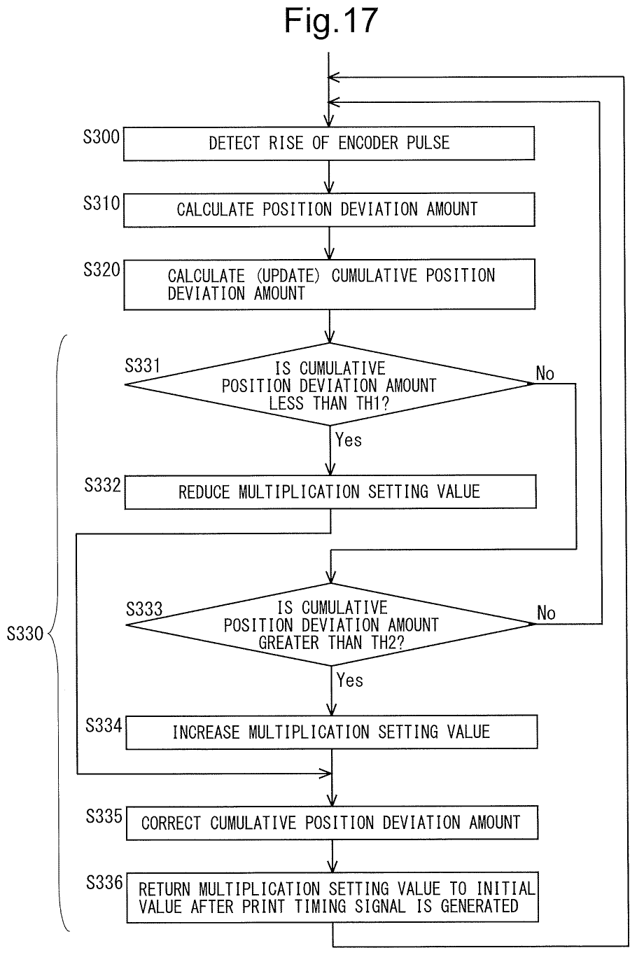

FIG. 17 is a flowchart showing a detailed procedure of the processes performed by the print timing signal correcting circuit 540. As can be understood from FIG. 17, every time the rising edge of the encoder pulse is detected (step S300), the processes from step S310 are performed.

In step S310, the position deviation amount occurring in the first unit period is calculated based on the encoder cycle length EL1 for the first unit period and the encoder cycle length EL2 for the second unit period. That is, in step S310, the position deviation amount occurring in the first unit period is calculated based on the length of the second unit period and the length of the first unit period.

Next, the cumulative position deviation amount MA, obtained by accumulating the position deviation amount, is calculated (step S320). Specifically, in step S320, the cumulative position deviation amount MA is updated by adding the position deviation amount calculated in step S310 to the immediately preceding cumulative position deviation amount MA.

Thereafter, it is determined whether the cumulative position deviation amount MA calculated in step S320 is less than the first threshold TH1 (step S331). As a result, when the cumulative position deviation amount MA is less than the first threshold TH1, the process proceeds to step S332, and when the cumulative position deviation amount MA is equal to or greater than the first threshold TH1, the process proceeds to step S333. In this regard, when the cumulative position deviation amount MA falls outside the position deviation allowable range during the period in which the conveyance speed (printing speed) is accelerated, the process proceeds from step S331 to step S332. In step S332, 1 is subtracted from the multiplication setting value.

In step S333, it is determined whether the cumulative position deviation amount MA calculated in step S320 is greater than the second threshold TH2. As a result, when the cumulative position deviation amount MA is greater than the second threshold TH2, the process proceeds to step S334, and when the cumulative position deviation amount MA is equal to or less than the second threshold TH2, the process returns to step S300. In this regard, when the cumulative position deviation amount MA falls outside the position deviation allowable range during the period in which the conveyance speed (printing speed) is decelerated, the process proceeds from step S333 to step S334. In step S334, 1 is added to the multiplication setting value.

After the multiplication setting value is changed in step S332 or step S334, the cumulative position deviation amount MA is corrected (step S335). Specifically, in a case where the multiplication setting value is changed in step S332, the first threshold TH1 is subtracted from the cumulative position deviation amount MA after step S332, and in a case where the multiplication setting value is changed in step S334, the second threshold TH2 is subtracted from the cumulative position deviation amount MA after step S334. Thereafter, the print timing signal PT is generated by the print timing signal generating circuit 530, and then the multiplication setting value is changed to the initial value (step S336). Assuming that the multiplication setting value after being changed in step S332 or step S334 is defined as an “adjusted value”, as described above, when the print timing signal PT is generated after the multiplication setting value is changed from the predetermined initial value (reference value) to the adjusted value, the multiplication setting value is changed from the adjusted value to the initial value (reference value). Thereafter, the process returns to step S300.

### <3.4 Supplement>

Since the position deviation amount is calculated by the above equation (1), the position deviation amount and the cumulative position deviation amount MA are negative values during the acceleration of the conveyance speed, and the position deviation amount and the cumulative position deviation amount MA are positive values during the deceleration of the conveyance speed. For this reason, 1 is subtracted from the multiplication setting value when the cumulative position deviation amount MA becomes less than the first threshold TH1, and 1 is added to the multiplication setting value when the cumulative position deviation amount MA becomes greater than the second threshold TH2. However, instead of the above equation (1), a position deviation amount Z(T1) occurring in the period T1 (cf. FIG. 5) may be calculated by the following equation (5).

$$Z ( T 1 ) = ( V 1 - V 0 ) \times T 1 \qquad ( 5 )$$

When the configuration in which the position deviation amount is calculated by the above equation (5) is adopted, the position deviation amount and the cumulative position deviation amount MA are positive values during the acceleration of the conveyance speed, and the position deviation amount and the cumulative position deviation amount MA are negative values during the deceleration of the conveyance speed. In this case, with the first threshold TH1 regarded as a negative value and the second threshold TH2 regarded as a positive value, when it is determined in step S331 of FIG. 17 that the cumulative position deviation amount MA is less than the first threshold TH1, 1 is added to the multiplication setting value in step S332, and when it is determined in step S333 of FIG. 17 that the cumulative position deviation amount MA is greater than the second threshold TH2, 1 is subtracted from the multiplication setting value in step S334.

### 4 Specific Example

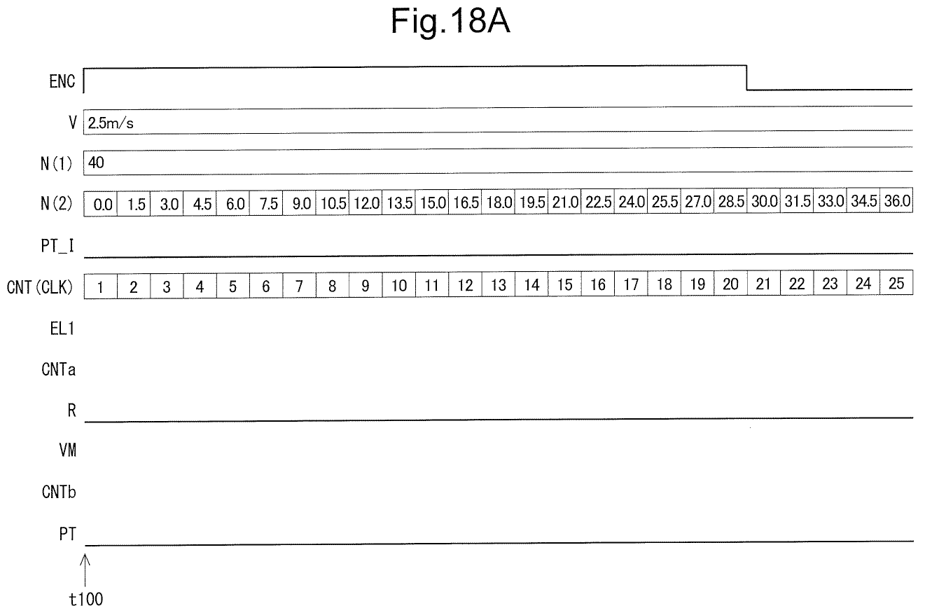

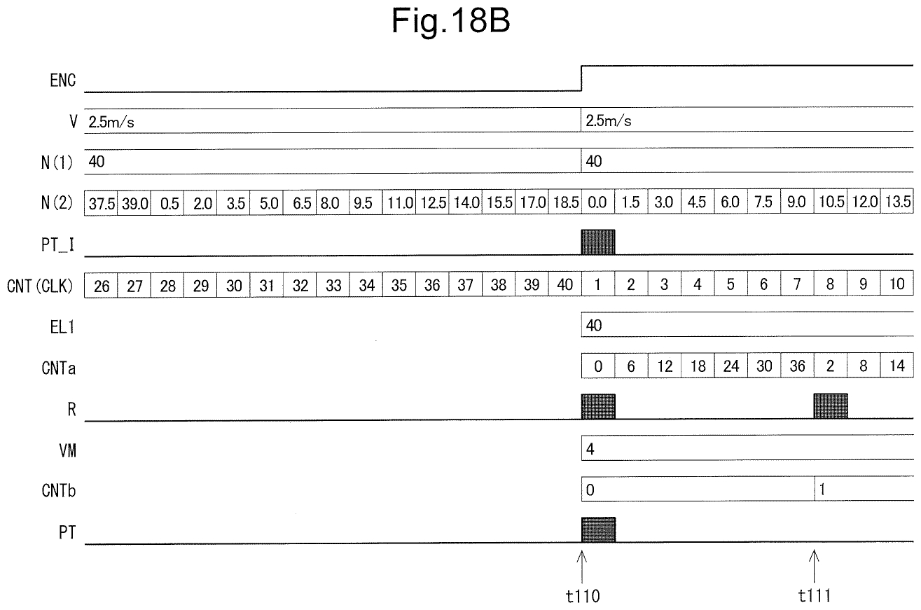

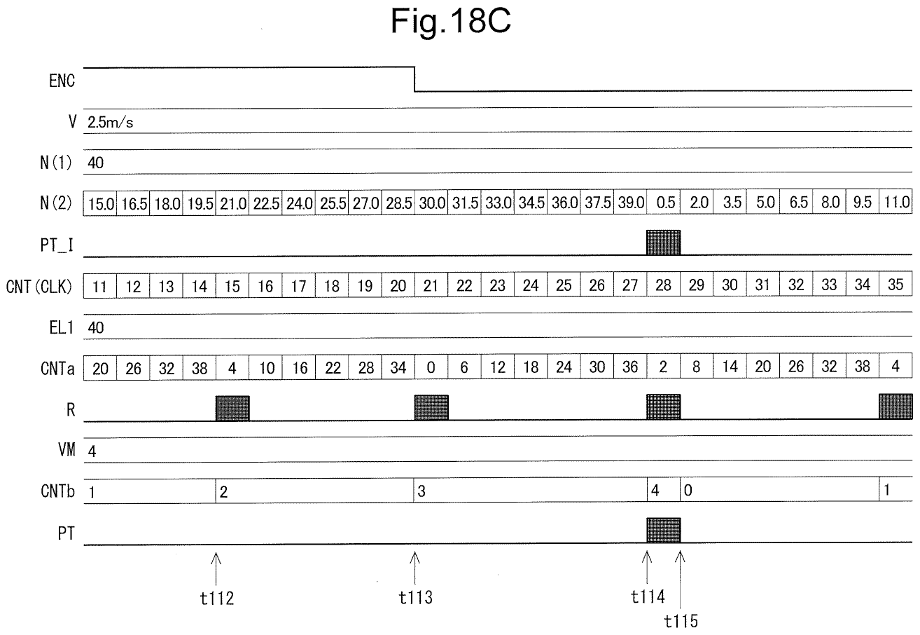

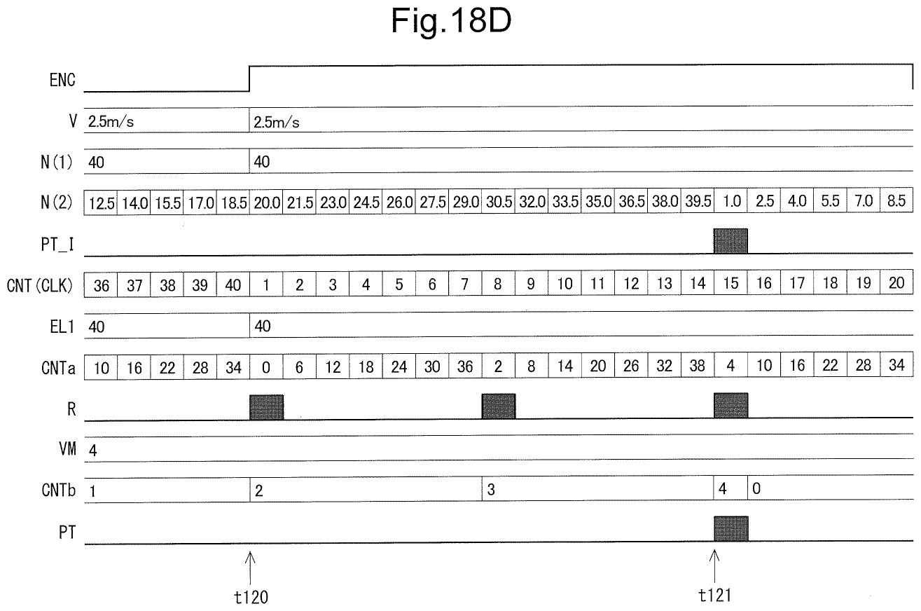

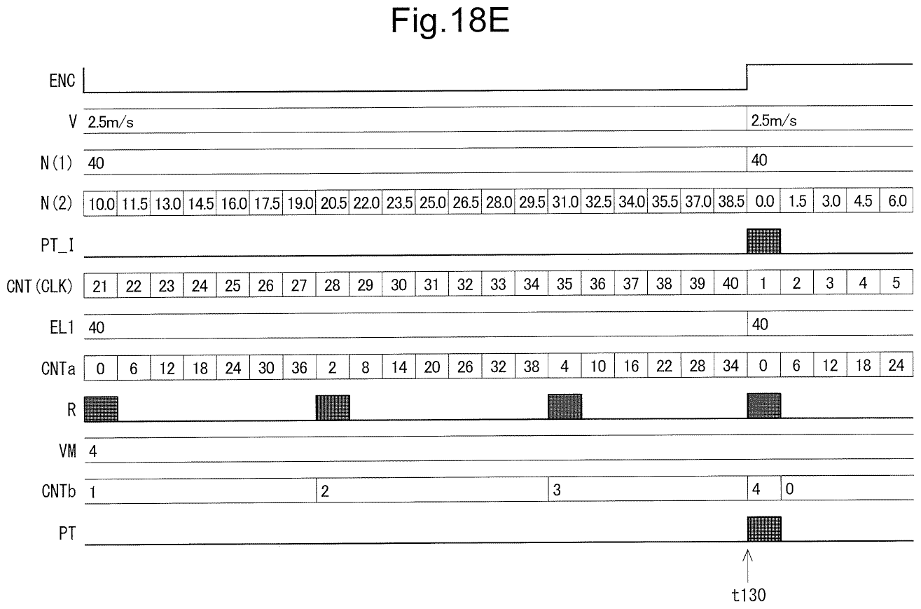

Hereinafter, a specific operation example will be described with reference to a timing chart. Regarding the timing chart in FIG. 18A and the like, V represents a conveyance speed, N(1) represents an encoder cycle length for the corresponding unit period, N(2) represents a value of a counter in a case where it is assumed that there exists the counter whose value is incremented by 1.5 every time the internal clock CLK is generated, PT_I represents an ideal print timing signal, and VM represents a multiplication setting value. In the following example, the encoder pulse is outputted every time the printing paper 5 is conveyed 100 μm, the internal clock CLK is generated every 1 μs, the dot spacing is 66.7 μm (in other words, ideally the print timing signal PT is generated every time the printing paper 5 is conveyed 66.7 μm), and the initial value of the multiplication setting value VM is 4. Since the encoder pulse is outputted every time the printing paper 5 is conveyed 100 μm and the dot spacing is 66.7 μm, the number of times the print timing signal PT is to be generated in each unit period is 1.5, and the number of times the reference signal R is to be generated in each unit period is 6. In addition, since the initial value of the multiplication setting value VM is 4 and the dot spacing is 66.7 μm (i.e., the distance corresponding to one cycle of the print timing signal PT is 66.7 μm), the distance corresponding to one cycle of the reference signal R is 16.67 μm. Since the position deviation allowable range is set to the distance corresponding to one cycle of the reference signal R as described above, the position deviation allowable range is 16.67 μm. Therefore, the first threshold TH1 is-16.67 μm, and the second threshold TH2 is 16.67 μm. Thus, in the present embodiment, the absolute value of the first threshold TH1 is equal to the second threshold TH2.

### <4.1 Operation Example at Constant Speed>

Prior to description of operation examples during acceleration and deceleration, an operation example at constant speed will be described as a comparative example (cf. FIGS. 18A, 18B, 18C, 18D, and 18E). In this example, the conveyance speed V is maintained at 2.5 m/s.

At time t110, the length of the unit period from time t100 to time t110 is acquired. Since the internal clock CLK is generated 40 times in the unit period from time t100 to time t110, the length of the unit period is 40 μs. Therefore, in the unit period from time t110 to time t120, when the first counter value CNTa becomes 40 or more, the reference signal R is generated and 1 is added to the second counter value CNTb.

At time t110, the first counter value CNTa is 0, the multiplication setting value VM is 4, and the second counter value CNTb is 0. Thereafter, 6 is added to the first counter value CNTa every time the internal clock CLK is generated. As a result, the first counter value CNTa becomes 42 at time t111. That is, the first counter value CNTa becomes 40 or more at time t111. Thus, the reference signal R is generated, and the second counter value CNTb becomes 1. At time t111, since the second counter value CNTb is less than the multiplication setting value VM, the print timing signal PT is not generated. Further, 40 is subtracted from the first counter value CNTa, and the first counter value CNTa becomes 2.

Similarly to time t111, the reference signal R is generated at time t112 and time t113. At both time t112 and time t113, since the second counter value CNTb is less than the multiplication setting value VM, the print timing signal PT is not generated.

Thereafter, the reference signal R is generated at time t114, and the second counter value CNTb becomes 4. At this time, since the multiplication setting value VM is 4, the second counter value CNTb becomes equal to the multiplication setting value VM. Thus, the print timing signal PT is generated at time t114. Then, at time t115, the second counter value CNTb is set to 0.

At time t120, the length of the unit period from time t110 to time t120 is acquired. Since the internal clock CLK is generated 40 times in the unit period from time t110 to time t120, the length of the unit period is 40 μs. Therefore, in the unit period from time t120 to time t130, as in the unit period from time t110 to time t120, when the first counter value CNTa becomes 40 or more, the reference signal R is generated and 1 is added to the second counter value CNTb.

Since the length of the unit period from time t100 to time t110 is equal to the length of the unit period from time t110 to time t120, there is no position deviation in the unit period from time t110 to time t120.

After time t120, at time t121 and time t130, the fourth reference signal R is generated after the immediately preceding print timing signal PT is generated. That is, at time t121 and time t130, the second counter value CNTb becomes equal to the multiplication setting value VM, and the print timing signal PT is generated. Similarly to the unit period from time t110 to time t120, there is no position deviation in the unit period from time t120 to time t130.

As above, when the conveyance speed is maintained at a constant speed, the print timing signal PT is always generated every time the reference signal R is generated four times. The position deviation does not occur, and as shown in FIGS. 18B, 18C, 18D, and 18E, the actual print timing signal PT is generated at the timing when the ideal print timing signal PT_I is to be generated.

### <4.2 Operation Example During Acceleration>

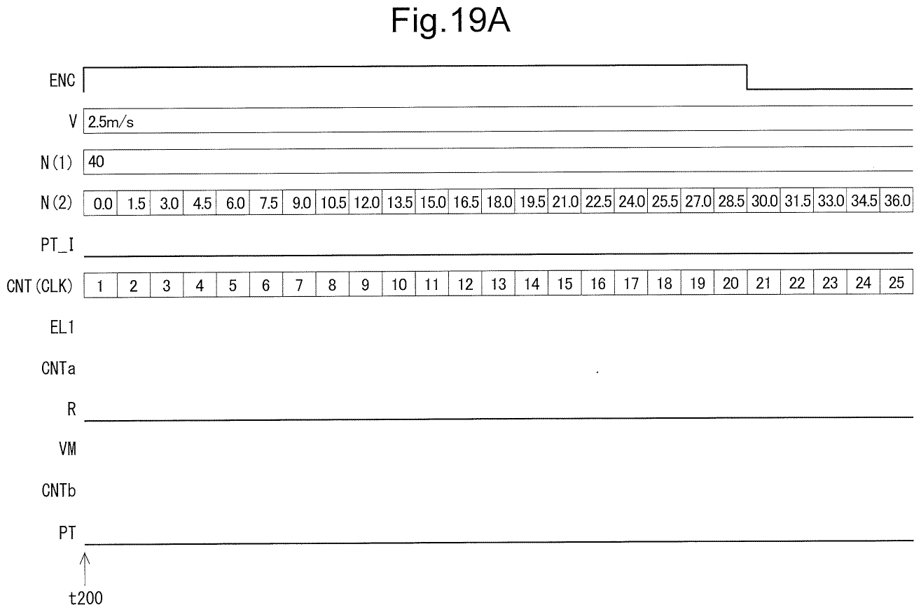

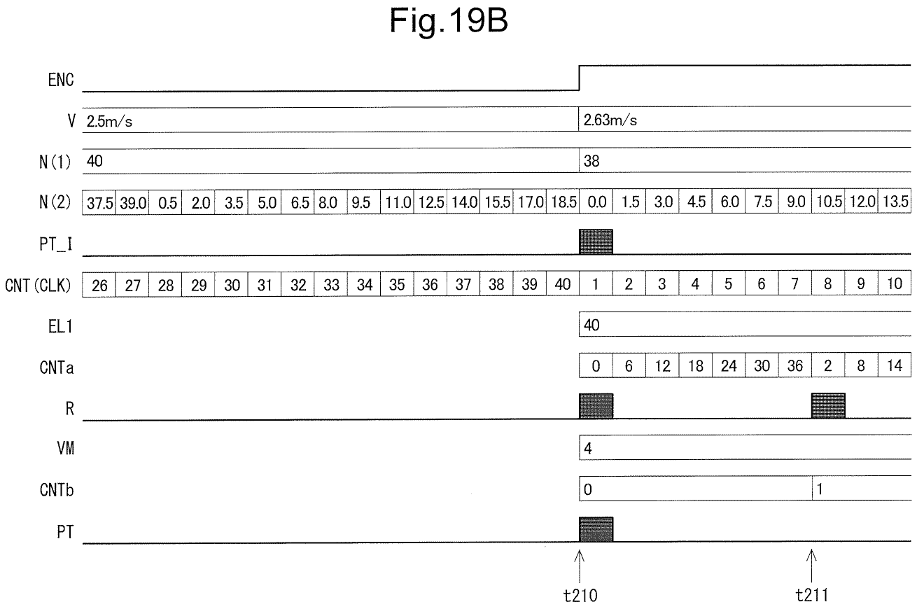

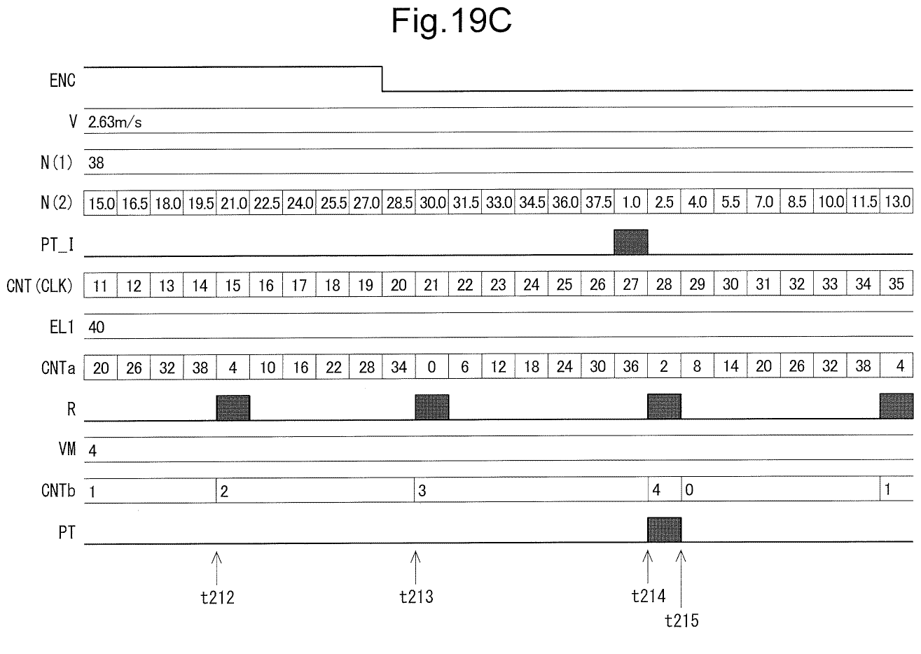

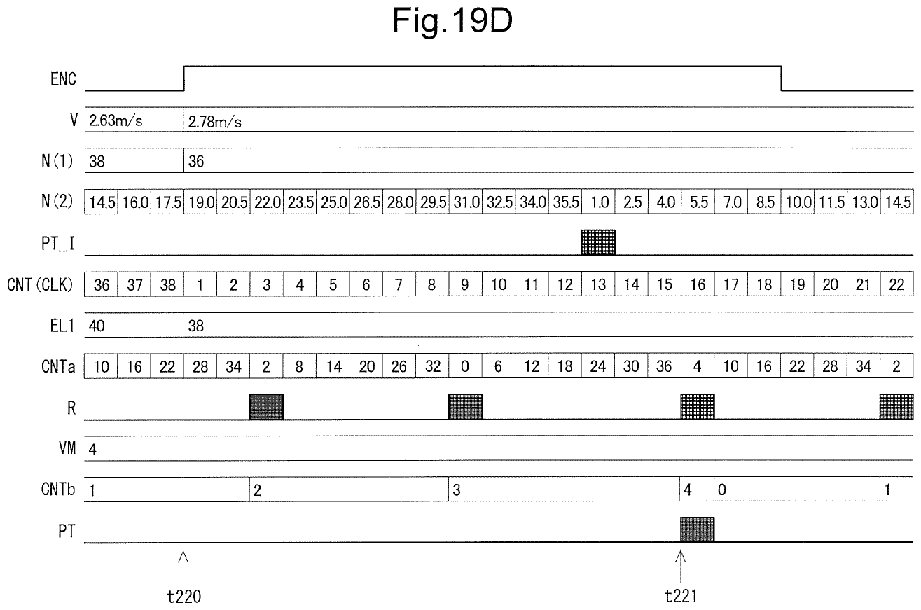

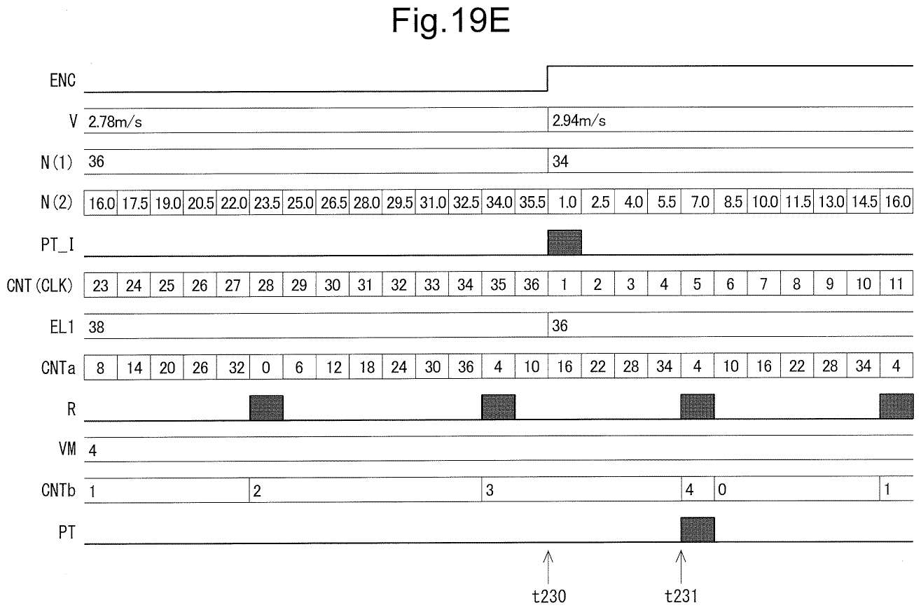

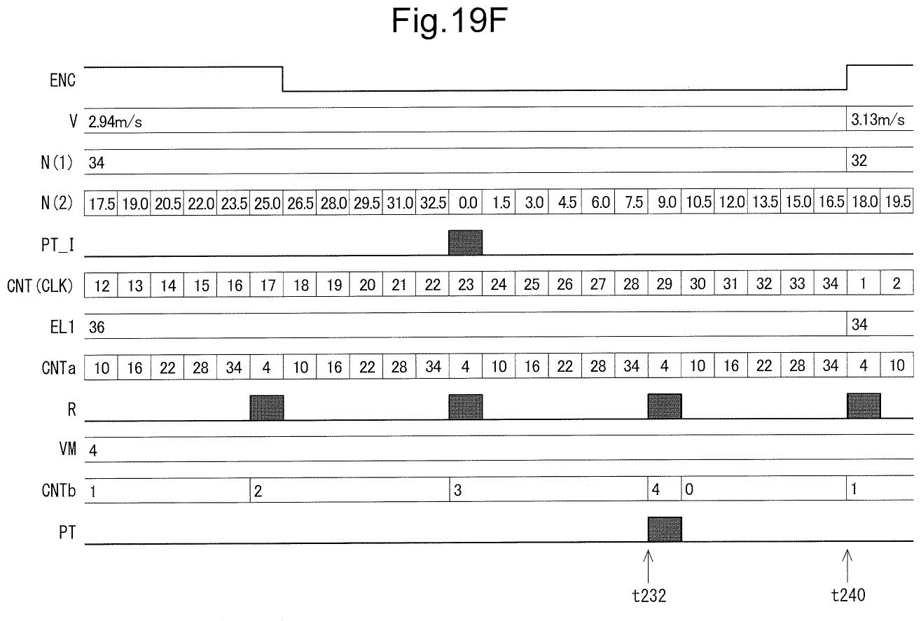

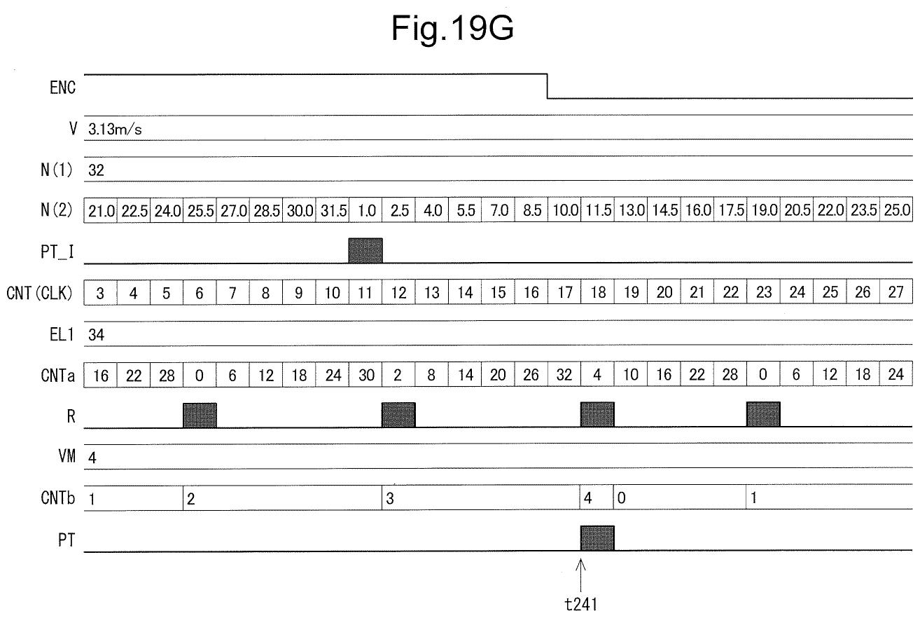

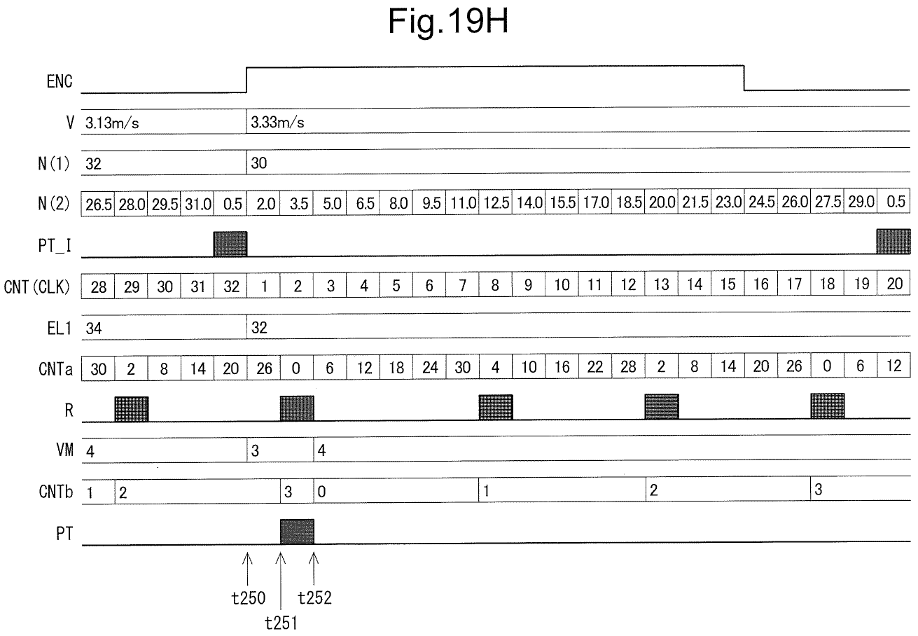

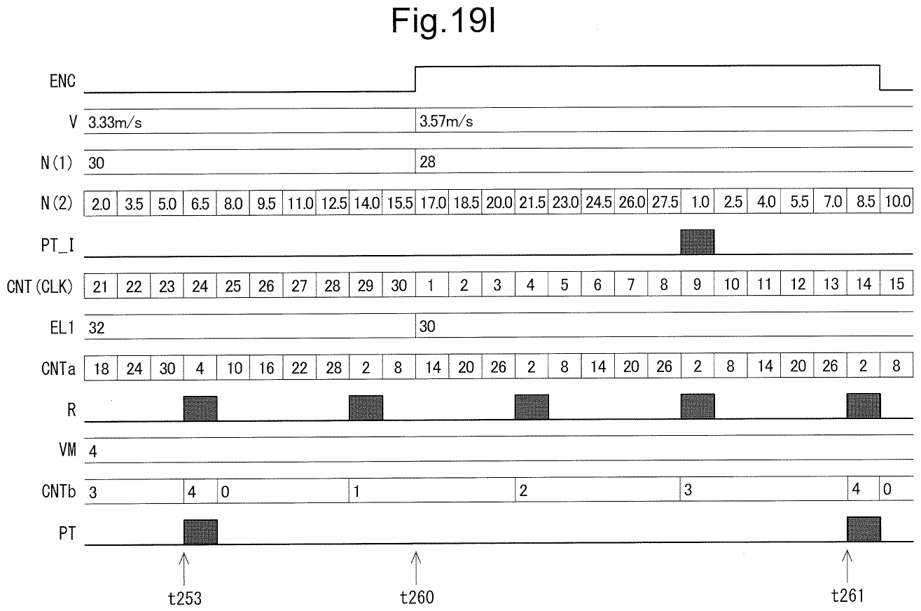

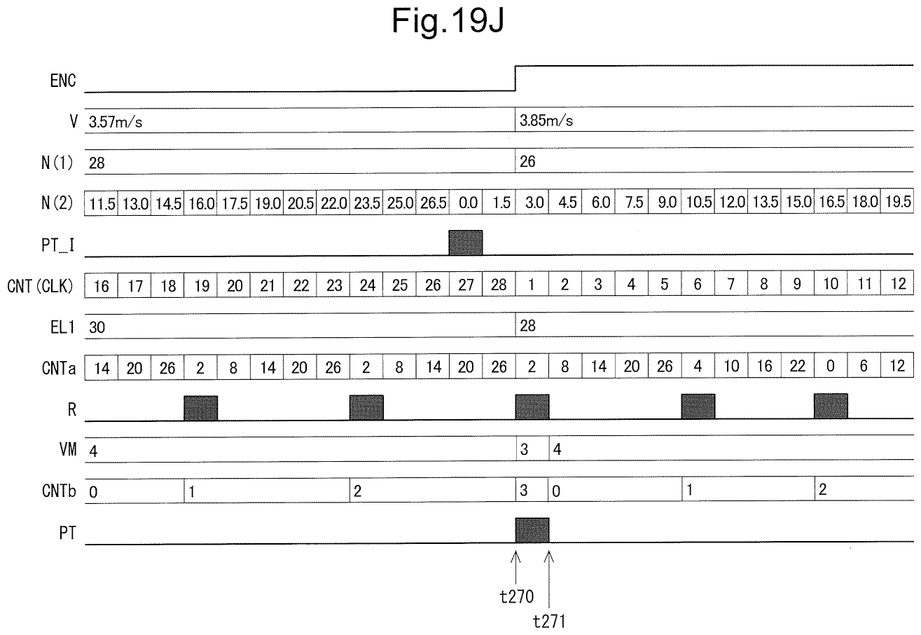

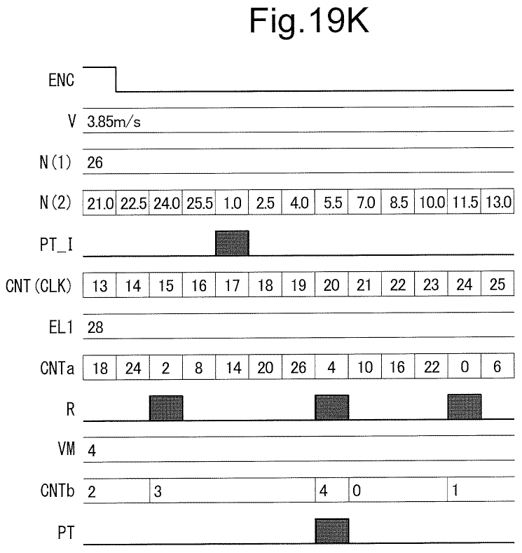

A specific example of generating the print timing signal PT during the acceleration of the conveyance speed will be described with reference to FIGS. 19A, 19B, 19C, 19D, 19E, 19F, 19G, 19H, 19I, 19J, and 19K. Here, attention is paid to an example in which the conveyance speed is gradually accelerated from 2.5 m/s to 3.85 m/s.

At time t210, the length of the unit period from time t200 to time t210 is acquired. Since the internal clock CLK is generated 40 times in the unit period from time t200 to time t210, the length of the unit period is 40 μs. Therefore, in the unit period from time t210 to time t220, when the first counter value CNTa becomes 40 or more, the reference signal R is generated and 1 is added to the second counter value CNTb.

At time t210, the first counter value CNTa is 0, the multiplication setting value VM is 4, and the second counter value CNTb is 0. Thereafter, 6 is added to the first counter value CNTa every time the internal clock CLK is generated. As a result, the first counter value CNTa becomes 42 at time t211. That is, the first counter value CNTa becomes 40 or more at time t211. Thus, the reference signal R is generated, and the second counter value CNTb becomes 1. At time t211, since the second counter value CNTb is less than the multiplication setting value VM, the print timing signal PT is not generated. Further, 40 is subtracted from the first counter value CNTa, and the first counter value CNTa becomes 2.

Similarly to time t211, the reference signal R is generated at time t212 and time t213. At both time t212 and time t213, since the second counter value CNTb is less than the multiplication setting value VM, the print timing signal PT is not generated.

Thereafter, the reference signal R is generated at time t214, and the second counter value CNTb becomes 4. At this time, since the multiplication setting value VM is 4, the second counter value CNTb becomes equal to the multiplication setting value VM. Thus, the print timing signal PT is generated at time t214. Then, at time t215, the second counter value CNTb is set to 0.

At time t220, the length of the unit period from time t210 to time t220 is acquired. Since the internal clock CLK is generated 38 times in the unit period from time t210 to time t220, the length of the unit period is 38 μs. Since the encoder pulse is outputted every time the printing paper 5 is conveyed 100 μm, the conveyance speed V in the unit period from time t210 to time t220 is 2.63 m/s. Since the length of the unit period from time t210 to time t220 is 38 μs, in the unit period from time t220 to time t230, when the first counter value CNTa becomes 38 or more, the reference signal R is generated and 1 is added to the second counter value CNTb.

The length of the unit period from time t200 to time t210 is 40 μs, whereas the length of the unit period from time t210 to time t220 is 38 μs. Therefore, a position deviation occurs in the unit period from time t210 to time t220. According to the above equation (1), the position deviation amount generated in the unit period from time t210 to time t220 is calculated to be −5 μm.

At time t220, the cumulative position deviation amount MA is −5 μm. Therefore, the cumulative position deviation amount MA is greater than the first threshold TH1 (the cumulative position deviation amount MA is within the position deviation allowable range). Thus, the multiplication setting value VM is maintained at 4.

In the unit period from time t220 to time t230, the second counter value CNTb becomes 4 when the reference signal R is generated at time t221. Therefore, at time t221, the second counter value CNTb becomes equal to the multiplication setting value VM, and the print timing signal PT is generated.

At time t230, the length of the unit period from time t220 to time t230 is acquired. Since the internal clock CLK is generated 36 times in the unit period from time t220 to time t230, the length of the unit period is 36 μs. Thus, the conveyance speed V in the unit period from time t220 to time t230 is calculated to be 2.78 m/s. At time t230, the position deviation amount occurring in the unit period from time t220 to time t230 is calculated. According to the above equation (1), the position deviation amount generated in the unit period from time t220 to time t230 is calculated to be −5.26 μm.

Since the position deviation amount generated in the unit period from time t210 to time t220 is −5 μm and the position deviation amount generated in the unit period from time t220 to time t230 is −5.26 μm, the cumulative position deviation amount MA at time t230 is −10.26 μm. Thus, the cumulative position deviation amount MA is greater than the first threshold TH1. Therefore, the multiplication setting value VM is maintained at 4.

In the unit period from time t230 to time t240, the second counter value CNTb becomes 4 when the reference signal R is generated at time t231 and time t232. Therefore, the print timing signal PT is generated at time t231 and time t232.

At time t240, the position deviation amount generated in the unit period from time t230 to time t240 is calculated to be −5.56 μm. The cumulative position deviation amount MA is −15.82 μm, which is greater than the first threshold TH1. Therefore, the multiplication setting value VM is still maintained at 4. Thereafter, the print timing signal PT is generated when the reference signal R is generated at time t241.

At time t250, the position deviation amount generated in the unit period from time t240 to time t250 is calculated to be −5.88 μm. As a result, the cumulative position deviation amount MA at the time t250 is −21.70 μm. Since the first threshold TH1 is −16.67 μm, at time t250, the cumulative position deviation amount MA becomes less than the first threshold TH1 (the cumulative position deviation amount MA falls outside the position deviation allowable range). Thus, 1 is subtracted from the multiplication setting value VM, and the multiplication setting value VM becomes 3. In addition, by subtracting the first threshold TH1 from the cumulative position deviation amount MA, the cumulative position deviation amount MA is calculated to be −5.03 μm.

Thereafter, at time t251, the reference signal R is generated and 1 is added to the second counter value CNTb. Thus, the second counter value CNTb becomes 3. As described above, the multiplication setting value VM is 3 at time t250. Therefore, when the second counter value CNTb becomes 3 at the time t251, the print timing signal PT is generated. After the print timing signal PT is generated in this manner, at time t252, the multiplication setting value VM is changed from 3 to the initial value 4, and the second counter value CNTb is set to 0. Thereafter, the print timing signal PT is generated when the reference signal R is generated at time t253.

At time t260, the position deviation amount generated in the unit period from time t250 to time t260 is calculated to be −6.25 μm. The cumulative position deviation amount MA is −11.28 μm, which is greater than the first threshold TH1. Therefore, the multiplication setting value VM is maintained at 4. Thereafter, the print timing signal PT is generated when the reference signal R is generated at time t261.

At time t270, the position deviation amount generated in the unit period from time t260 to time t270 is calculated to be −6.67 μm. As a result, the cumulative position deviation amount MA at the time t270 is −17.95 μm. Since the first threshold TH1 is −16.67 μm, at time t270, the cumulative position deviation amount MA becomes less than the first threshold TH1 (the cumulative position deviation amount MA falls outside the position deviation allowable range). Thus, 1 is subtracted from the multiplication setting value VM, and the multiplication setting value VM becomes 3. By subtracting the first threshold TH1 from the cumulative position deviation amount MA, the cumulative position deviation amount MA is calculated to be −1.28 μm. At time t270, the reference signal R is generated, and 1 is added to the second counter value CNTb. Thus, the second counter value CNTb becomes 3. Since the multiplication setting value VM is 3 as described above, the print timing signal PT is generated at time t270. Thereafter, at time t271, the multiplication setting value VM is changed from 3 to the initial value 4, and the second counter value CNTb is set to 0.

### <4.3 Operation Example During Deceleration>

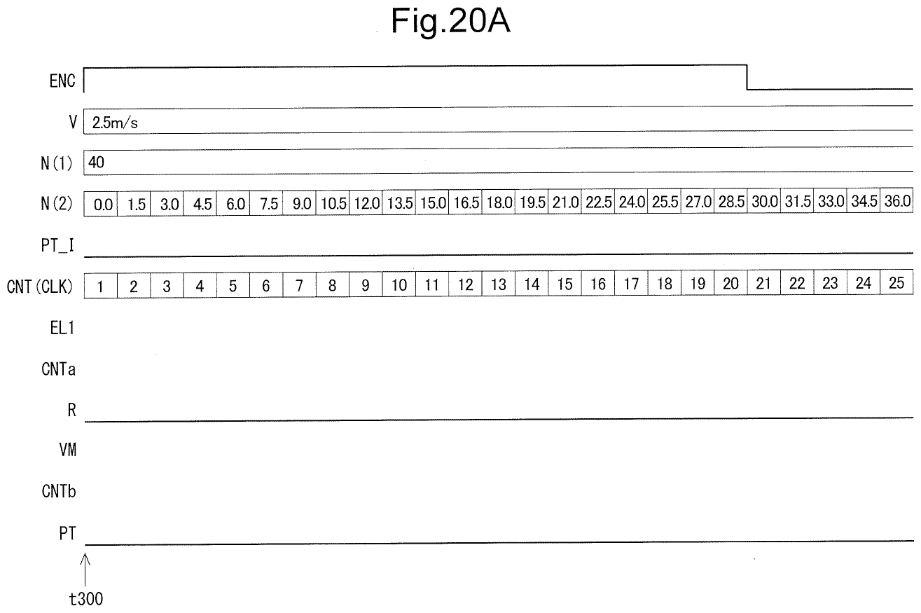

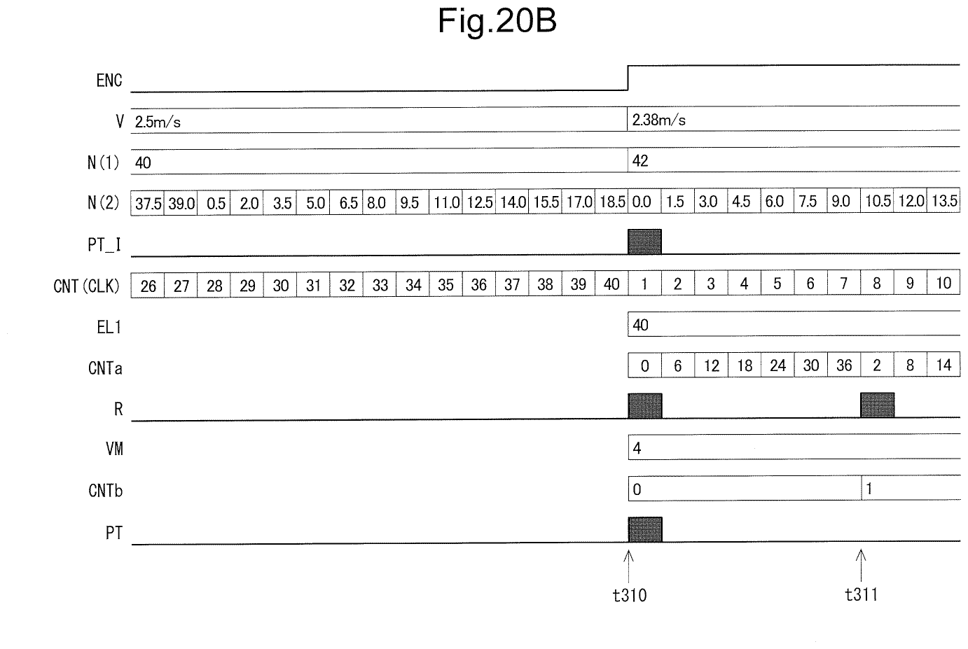

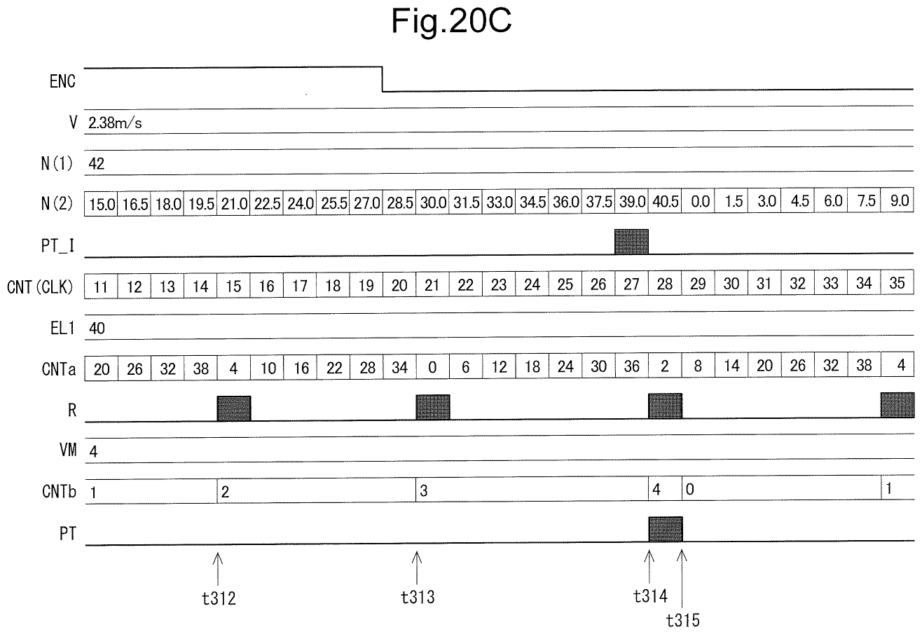

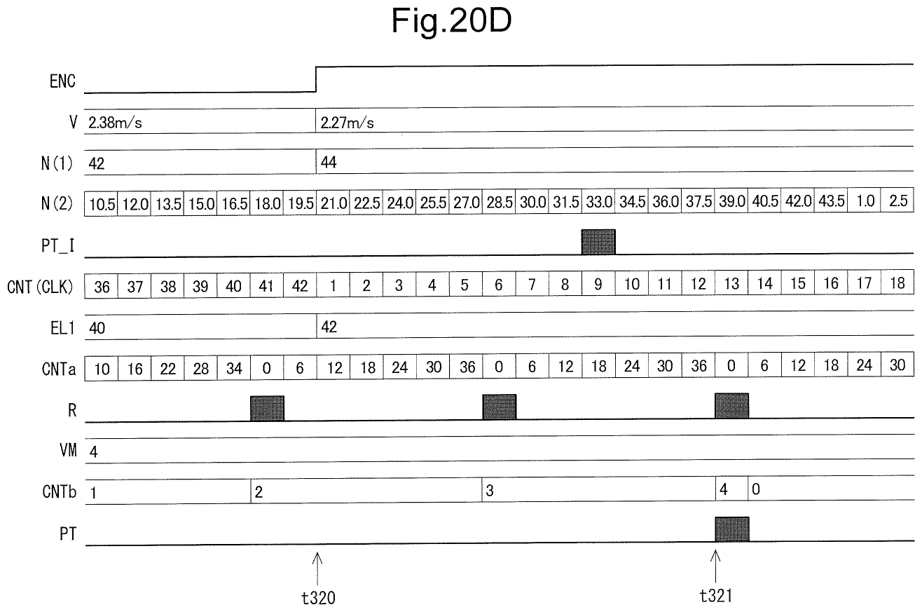

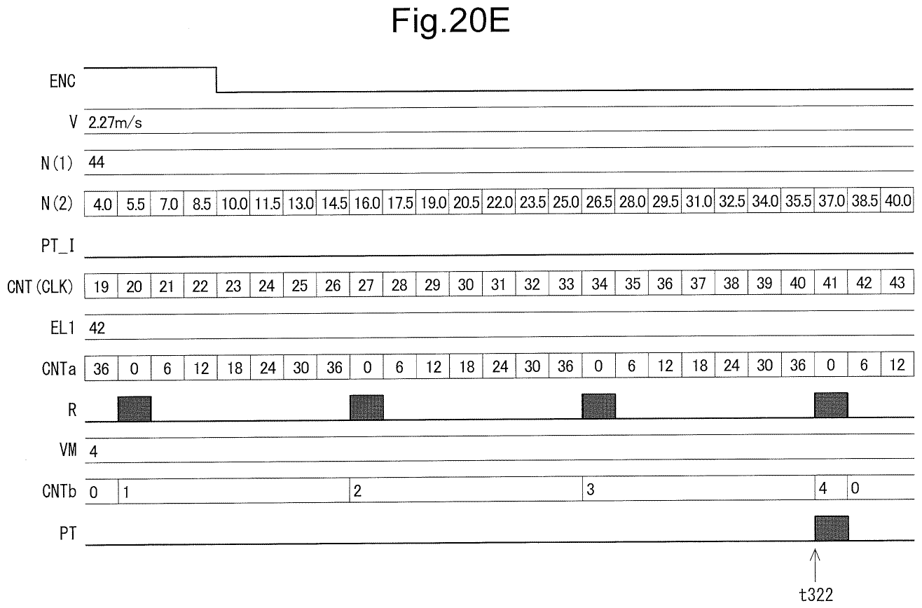

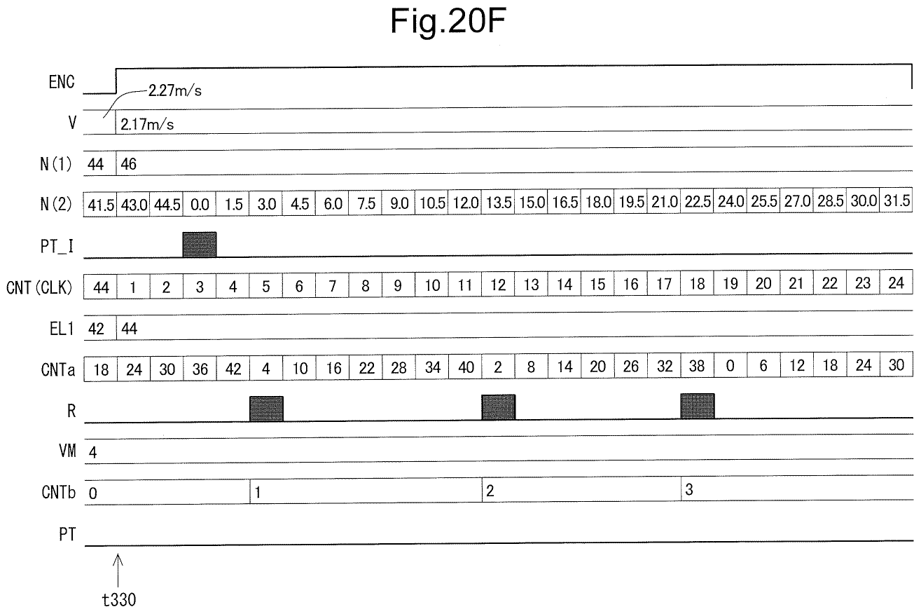

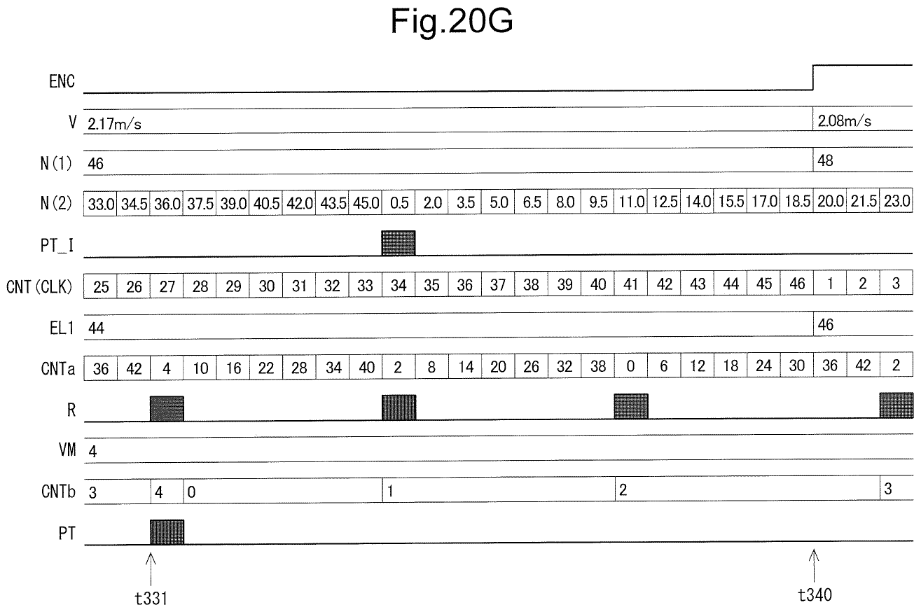

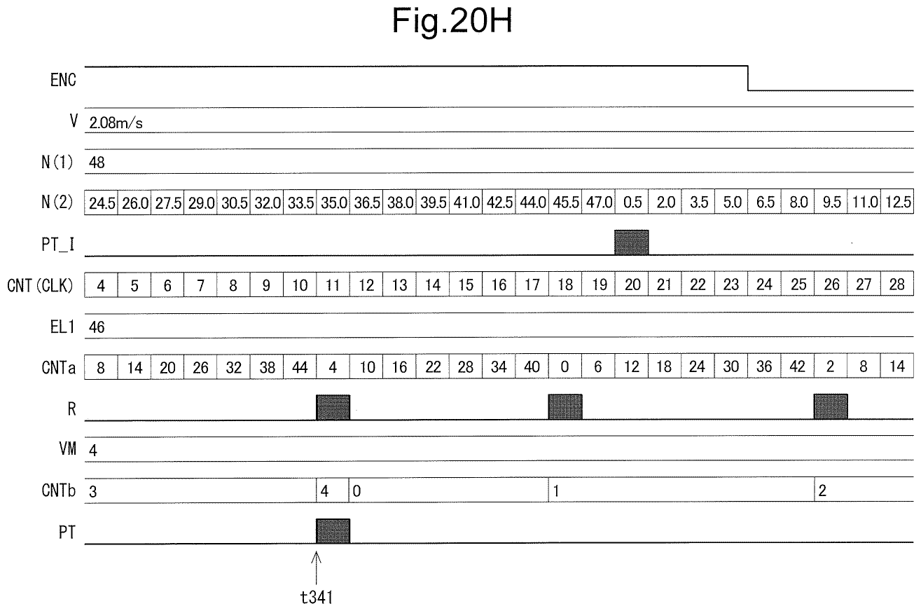

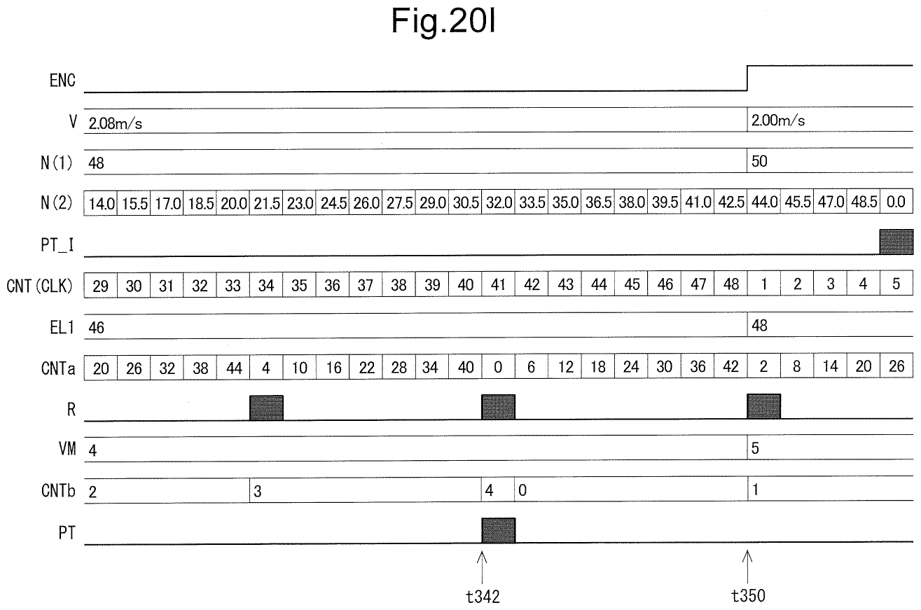

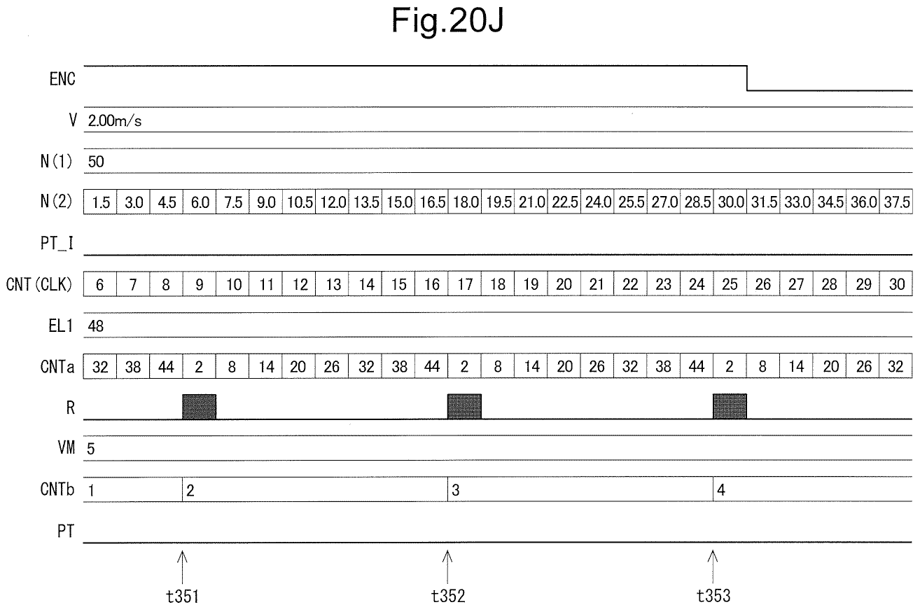

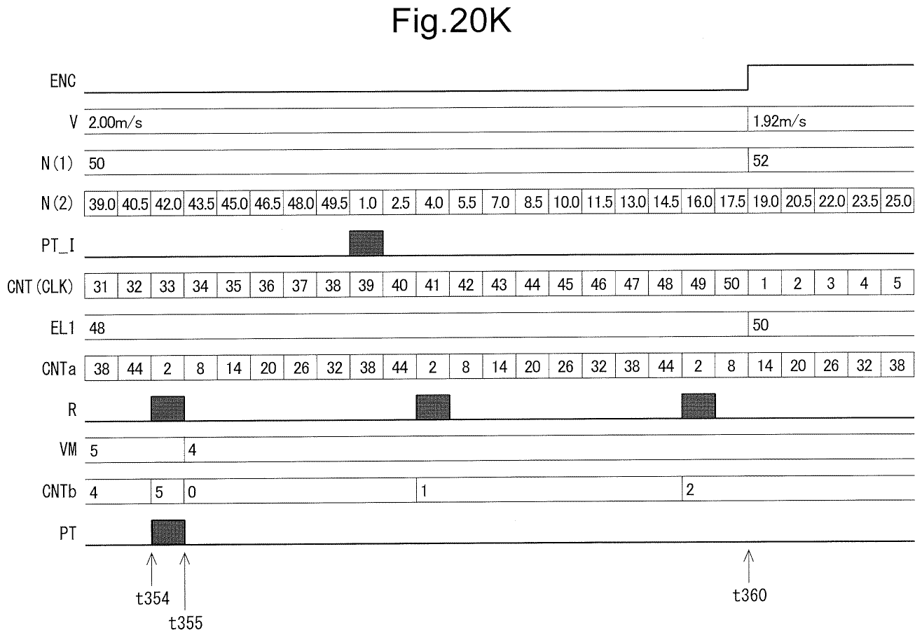

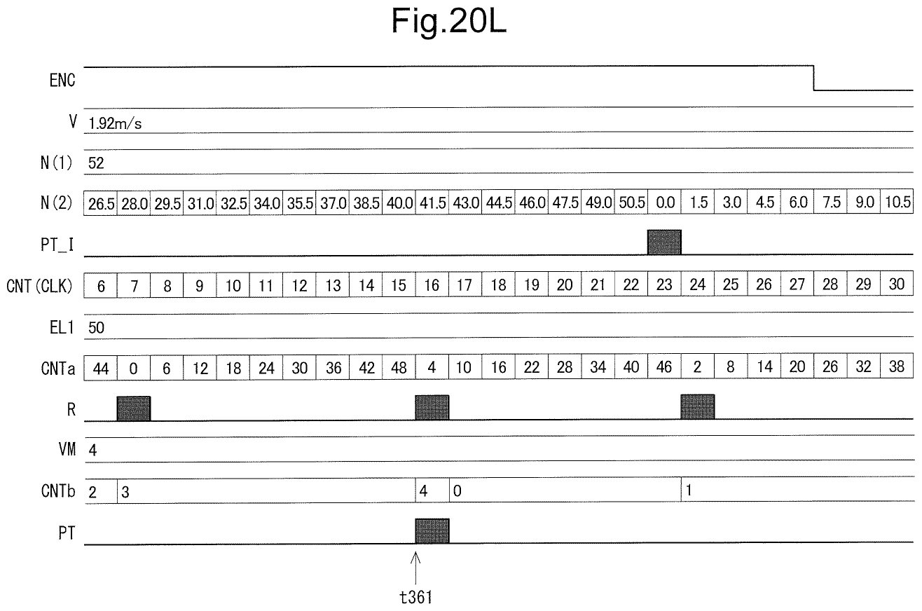

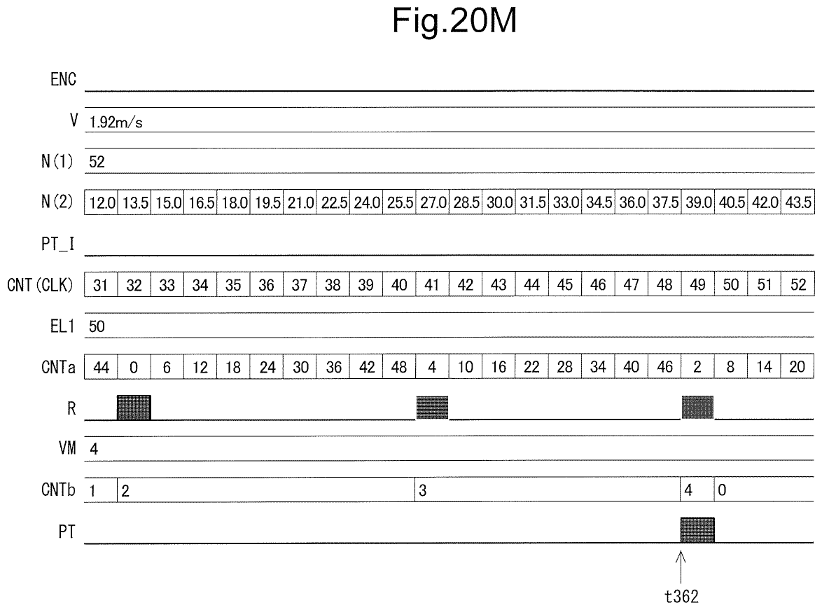

A specific example of generating the print timing signal PT during the deceleration of the conveyance speed will be described with reference to FIGS. 20A, 20B, 20C, 20D, 20E, 20F, 20G, 20H, 20I, 20J, 20K, 20L, and 20M. Here, attention is paid to an example in which the conveyance speed gradually decreases from 2.5 m/s to 2.0 m/s.

At time t310, the length of the unit period from time t300 to time t310 is acquired. Since the internal clock CLK is generated 40 times in the unit period from time t300 to time t310, the length of the unit period is 40 μs. Therefore, in the unit period from time t310 to time t320, when the first counter value CNTa becomes 40 or more, the reference signal R is generated and 1 is added to the second counter value CNTb.

At time t310, the first counter value CNTa is 0, the multiplication setting value VM is 4, and the second counter value CNTb is 0. Thereafter, 6 is added to the first counter value CNTa every time the internal clock CLK is generated. As a result, the first counter value CNTa becomes 42 at time t311. That is, the first counter value CNTa becomes 40 or more at time t311. Thus, the reference signal R is generated, and the second counter value CNTb becomes 1. At time t311, since the second counter value CNTb is less than the multiplication setting value VM, the print timing signal PT is not generated. Further, 40 is subtracted from the first counter value CNTa, and the first counter value CNTa becomes 2.

Similarly to time t311, the reference signal R is generated at time t312 and time t313. At both time t312 and time t313, since the second counter value CNTb is less than the multiplication setting value VM, the print timing signal PT is not generated.

Thereafter, the reference signal R is generated at time t314, and the second counter value CNTb becomes 4. At this time, since the multiplication setting value VM is 4, the second counter value CNTb becomes equal to the multiplication setting value VM. Thus, the print timing signal PT is generated at time t314. Then, at time t315, the second counter value CNTb is set to 0.

At time t320, the length of the unit period from time t310 to time t320 is acquired. Since the internal clock CLK is generated 42 times in the unit period from time t310 to time t320, the length of the unit period is 42 μs. Since the encoder pulse is outputted every time the printing paper 5 is conveyed 100 μm, the conveyance speed V in the unit period from time t310 to time t320 is 2.38 m/s. Since the length of the unit period from time t310 to time t320 is 42 μs, in the unit period from time t320 to time t330, when the first counter value CNTa becomes 42 or more, the reference signal R is generated and 1 is added to the second counter value CNTb.

The length of the unit period from time t300 to time t310 is 40 μs, whereas the length of the unit period from time t310 to time t320 is 42 μs. Therefore, a position deviation occurs in the unit period from time t310 to time t320. According to the above equation (1), the position deviation amount generated in the unit period from time t310 to time t320 is calculated to be 5 μm.

At time t320, the cumulative position deviation amount MA is 5 μm. Therefore, the cumulative position deviation amount MA is less than the second threshold TH2 (the cumulative position deviation amount MA is within the position deviation allowable range). Thus, the multiplication setting value VM is maintained at 4.

In the unit period from time t320 to time t330, the second counter value CNTb becomes 4 when the reference signal R is generated at time t321 and time t322. Therefore, at time t321 and time t322, the second counter value CNTb becomes equal to the multiplication setting value VM, and the print timing signal PT is generated.

At time t330, the length of the unit period from time t320 to time t330 is acquired. Since the internal clock CLK is generated 44 times in the unit period from time t320 to time t330, the length of the unit period is 44 μs. Thus, the conveyance speed V in the unit period from time t320 to time t330 is calculated to be 2.27 m/s. At time t330, the position deviation amount occurring in the unit period from time t320 to time t330 is calculated. According to the above equation (1), the position deviation amount generated in the unit period from time t320 to time t330 is calculated to be 4.76 μm.

Since the position deviation amount generated in the unit period from time t310 to time t320 is 5 μm and the position deviation amount generated in the unit period from time t320 to time t330 is 4.76 μm, the cumulative position deviation amount MA at time t330 is 9.76 μm. Therefore, the cumulative position deviation amount MA is less than the second threshold TH2. Thus, the multiplication setting value VM is maintained at 4.

In the unit period from time t330 to time t340, the second counter value CNTb becomes 4 when the reference signal R is generated at time t331. Therefore, the print timing signal PT is generated at time t331.

At time t340, the position deviation amount generated in the unit period from time t330 to time t340 is calculated to be 4.55 μm. The cumulative position deviation amount MA is 14.31 μm, which is less than the second threshold TH2. Therefore, the multiplication setting value VM is still maintained at 4. Thereafter, the print timing signal PT is generated when the reference signal R is generated at time t341 and time t342.

At time t350, the position deviation amount generated in the unit period from time t340 to time t350 is calculated to be 4.35 μm. As a result, the cumulative position deviation amount MA at the time t350 is 18.66 μm. Since the second threshold TH2 is 16.67 μm, at time t350, the cumulative position deviation amount MA becomes greater than the second threshold TH2 (the cumulative position deviation amount MA falls outside the position deviation allowable range). Thus, 1 is added to the multiplication setting value VM, and the multiplication setting value VM becomes 5. By subtracting the second threshold TH2 from the cumulative position deviation amount MA, the cumulative position deviation amount MA is calculated to be 1.99 μm.

The second counter value CNTb becomes 2 when the reference signal R is generated at time t351, the second counter value CNTb becomes 3 when the reference signal R is generated at time t352, and the second counter value CNTb becomes 4 when the reference signal R is generated at time t353. Since the multiplication setting value VM is 5 at time t350, the print timing signal PT is not generated even when the second counter value CNTb becomes 4 at time t353.

Thereafter, at time t354, the reference signal R is generated and 1 is added to the second counter value CNTb. Thus, the second counter value CNTb becomes 5. As described above, the multiplication setting value VM is 5 at time t350. Therefore, when the second counter value CNTb becomes 5 at the time t354, the print timing signal PT is generated. After the print timing signal PT is generated in this manner, at time t355, the multiplication setting value VM is changed from 5 to the initial value 4, and the second counter value CNTb is set to 0.

At time t360, the position deviation amount generated in the unit period from time t350 to time t360 is calculated to be 4.17 μm. The cumulative position deviation amount MA is 6.16 μm, which is less than the second threshold TH2. Therefore, the multiplication setting value VM is maintained at 4. Thereafter, the print timing signal PT is generated when the reference signal R is generated at time t361 and time t362.

### 5. Effects

According to the present embodiment, with the period from the rising edge of the encoder pulse to the next rising edge regarded as a unit period, based on the length of a second unit period that is a unit period two preceding and the length of a first unit period that is a unit period one preceding, the position deviation amount caused by the difference between the conveyance speed in the second unit period and the conveyance speed in the first unit period is calculated. In addition, the cumulative position deviation amount MA, obtained by accumulating the position deviation amount, is calculated. When the cumulative position deviation amount MA falls outside the position deviation allowable range, the setting value (multiplication setting value) of the multiplication factor representing the relationship between the frequency of the reference signal R used to generate the print timing signal PT and the frequency of the print timing signal PT is adjusted, and the print timing signal PT is generated so that the magnitude of the position deviation decreases. From the above, according to the present embodiment, the inkjet printing apparatus 10 capable of reducing the ink landing position deviation when acceleration/deceleration printing is performed, as compared to the related art, is realized. Furthermore, the reduction in ink landing position deviation decreases the necessity of reprinting, suppressing wasteful consumption of the printing paper 5 and ink. In this way, it is possible to contribute to the achievement of the sustainable development goals (SDGs).

### 6. Modifications

Hereinafter, modifications of the above embodiment will be described.

### <6.1 First Modification>

In the above embodiment, when the cumulative position deviation amount MA falls outside the position deviation allowable range, 1 is subtracted from the multiplication setting value during the acceleration of the conveyance speed, and 1 is added to the multiplication setting value during the deceleration of the conveyance speed. That is, when the cumulative position deviation amount MA falls outside the position deviation allowable range during the acceleration of the conveyance speed, the print timing signal PT is generated at a timing earlier than that in the normal state by a period corresponding to one cycle of the reference signal R, and when the cumulative position deviation amount MA falls outside the position deviation allowable range during the deceleration of the conveyance speed, the print timing signal PT is generated at a timing later than that in the normal state by a period corresponding to one cycle of the reference signal R. However, depending on the degree of acceleration or deceleration of the conveyance speed, it is preferable to make the timing for generating the print timing signal PT significantly different from that in the normal state. Therefore, in the present modification, the multiplication setting value is adjusted as follows.

In the present modification, with K regarded as a natural number, when the cumulative position deviation amount MA becomes less than K times the first threshold TH1, the adjustment circuit 544 (cf. FIG. 12) in the print timing signal correcting circuit 540 provides the multiplication factor change instruction data MD instructing to subtract K from the multiplication setting value to the print timing signal generation counter 533, and when the cumulative position deviation amount MA becomes greater than K times the second threshold TH2, the adjustment circuit 544 provides the multiplication factor change instruction data MD instructing to add K to the multiplication setting value to the print timing signal generation counter 533.

When it is determined in step S331 of FIG. 17 that the cumulative position deviation amount MA is less than the first threshold TH1, the multiplication setting value is subtracted in step S332 as follows (at this time, the cumulative position deviation amount MA and the first threshold TH1 are negative values). When the cumulative position deviation amount MA is equal to or greater than twice the first threshold TH1 and less than the first threshold TH1, 1 is subtracted from the multiplication setting value. When the cumulative position deviation amount MA is equal to or more than three times the first threshold TH1 and less than two times the first threshold TH1, 2 is subtracted from the multiplication setting value. When the cumulative position deviation amount MA is equal to or more than four times the first threshold TH1 and less than three times the first threshold TH1, 3 is subtracted from the multiplication setting value. In this way, with K regarded as a natural number, when the cumulative position deviation amount MA becomes less than K times the first threshold TH1, K is subtracted from the multiplication setting value.

Further, when it is determined in step S333 of FIG. 17 that the cumulative position deviation amount MA is greater than the second threshold TH2, the multiplication setting value is increased in step S334 as follows (at this time, the cumulative position deviation amount MA and the second threshold TH2 are positive values). When the cumulative position deviation amount MA is greater than the second threshold TH2 and equal to or less than twice the second threshold TH2, 1 is added to the multiplication setting value. When the cumulative position deviation amount MA is greater than twice the second threshold TH2 and equal to or less than three times the second threshold TH2, 2 is added to the multiplication setting value. When the cumulative position deviation amount MA is greater than three times the second threshold TH2 and equal to or less than four times the second threshold TH2, 3 is added to the multiplication setting value. In this way, with K regarded as a natural number, when the cumulative position deviation amount MA becomes greater than K times the second threshold TH2, K is added to the multiplication setting value.

In a case where the position deviation amount is calculated by the above equation (5) instead of the above equation (1), the multiplication setting value is adjusted as follows, with the first threshold TH1 regarded as a negative value and the second threshold TH2 regarded as a positive value. With K regarded as a natural number, when the cumulative position deviation amount MA becomes less than K times the first threshold TH1, K is added to the multiplication setting value, and when the cumulative position deviation amount MA becomes greater than K times the second threshold TH2, K is subtracted from the multiplication setting value.

According to the present modification, addition or subtraction of the multiplication setting value is performed depending on the degree of acceleration or deceleration of the conveyance speed. Therefore, even when the conveyance speed is greatly accelerated or greatly decelerated, the ink landing position deviation is effectively reduced.

### <6.2 Second Modification>

In the above embodiment, the position deviation amount is calculated by the above equation (1) or the above equation (5). In that case, a negative value appears as the value of the position deviation amount. In contrast, in the present modification, to prevent the position deviation amount from becoming a negative value, the position deviation amount (distance of position deviation) Z(T1) occurring in period T1 is calculated by the following equation (6) regarding the example shown in FIG. 5, assuming that the conveyance speed in period T0 is V0 and the conveyance speed in period T1 is V1.

$$Z ( T 1 ) = \vert V 0 - V 1 \vert \times T 1 \qquad ( 6 )$$

As can be understood from the above equation (6), in the present modification, the product of the absolute value of the difference between the conveyance speed in the second unit period and the conveyance speed in the first unit period, and the length of the first unit period, is calculated as the position deviation amount. According to the above equation (6), since the position deviation amount is not a negative value, the cumulative position deviation amount is also not a negative value. That is, when the position deviation occurs, both the position deviation amount and the cumulative position deviation amount are positive values. Therefore, in the present modification, only one threshold for comparison with the cumulative position deviation amount is provided. The threshold is also a positive value.

Regarding a case where the cumulative position deviation amount MA becomes greater than the threshold, it is necessary to subtract 1 from the multiplication setting value during the acceleration of the conveyance speed, and it is necessary to add 1 to the multiplication setting value during the deceleration of the conveyance speed. Therefore, whether the conveyance speed is being accelerated or decelerated is determined based on the relationship between the length of the first unit period (the encoder cycle length EL1 for the first unit period) and the length of the second unit period (the encoder cycle length EL2 for the second unit period). Specifically, when the length of the first unit period is shorter than the length of the second unit period, it is determined that the conveyance speed is being accelerated, and when the length of the first unit period is longer than the length of the second unit period, it is determined that the conveyance speed is being decelerated.

From the above, in the present modification, when the cumulative position deviation amount MA becomes greater than the threshold in a case where the length of the first unit period is shorter than the length of the second unit period, 1 is subtracted from the multiplication setting value, and when the cumulative position deviation amount MA becomes greater than the threshold in a case where the length of the first unit period is longer than the length of the second unit period, 1 is added to the multiplication setting value.

Note that the present modification and the first modification may be combined to adjust the multiplication setting value as follows. With K regarded as a natural number, when the cumulative position deviation amount MA becomes greater than K times the threshold in a case where the length of the first unit period is shorter than the length of the second unit period, K is subtracted from the multiplication setting value, and when the cumulative position deviation amount MA becomes greater than K times the threshold in a case where the length of the first unit period is longer than the length of the second unit period, K is added to the multiplication setting value.

### <6.3 Third Modification>

In the above embodiment, the inkjet printing apparatus 10 capable of single-sided printing has been adopted. However, the present invention is not limited thereto. The present invention is also applicable to a case where the inkjet printing apparatus 10 capable of double-sided printing is adopted, as in the present modification.

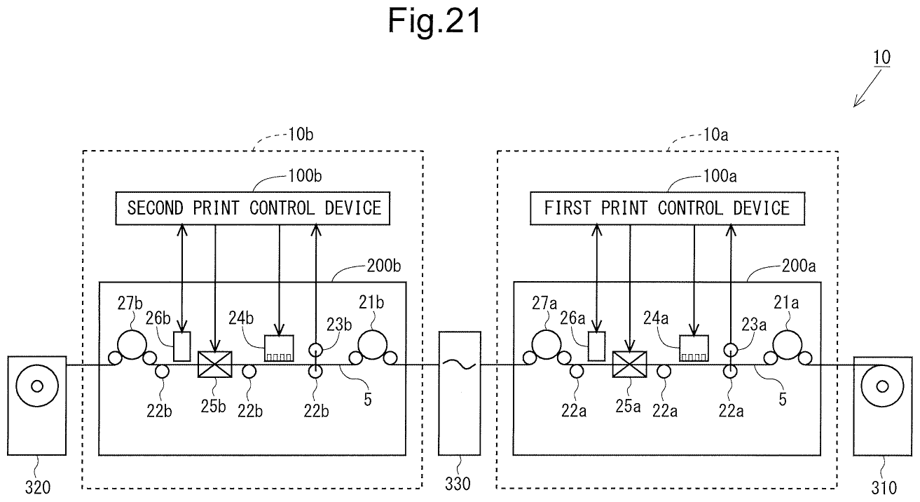

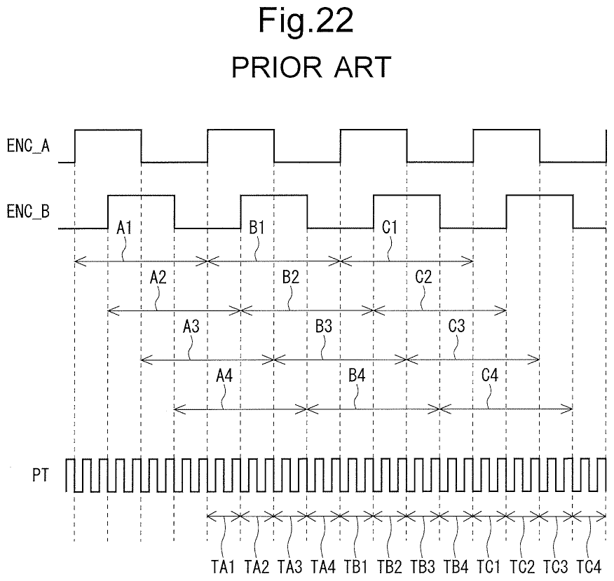

FIG. 21 is a schematic diagram showing one configuration example of the inkjet printing apparatus 10 in the present modification. The inkjet printing apparatus 10 in the present modification includes a paper feeding unit 310, a front-side printer 10a, a reversing unit 330 that reverses the front side and the back side of the printing paper 5, a back-side printer 10b, and a paper winding unit 320. The front-side printer 10a includes a printer body 200a for front-side printing, and a first print control device 100a that controls the operation of the printer body 200a. The back-side printer 10b includes a printer body 200b for back-side printing, and a second print control device 100b that controls the operation of the printer body 200b. The internal configurations of the printer bodies 200a, 200b are similar to the internal configuration of the printer body 200 in the above embodiment. Note that the components of the front-side printer 10a are denoted by “a” at the end of the reference numerals, and the components of the back-side printer 10b are denoted by “b” at the end of the reference numerals.

In the configuration as described above, in the front-side printer 10a, the first print control device 100a generates the print timing signal PT that defines a timing at which ink is ejected from each of print heads 241 constituting a recording unit 24a, based on the encoder signal outputted from an encoder 23a. In the back-side printer 10b, the second print control device 100b generates the print timing signal PT that defines a timing at which ink is ejected from each of print heads 241 constituting a recording unit 24b, based on the encoder signal outputted from an encoder 23b. In this regard, the generation of the print timing signal PT in the first print control device 100a and the second print control device 100b is performed in the same manner as in the above embodiment.

According to the present modification, in a case where acceleration/deceleration printing is performed by the inkjet printing apparatus 10 capable of double-sided printing, it is possible to reduce the ink landing position deviation on both the front side of the printing paper 5 and the back side of the printing paper 5, as compared to the related art.

### 7. Others

The present invention is not limited to the above embodiment (including the modifications), and various modifications can be made without departing from the gist of the present invention. For example, in the above embodiment (including the modifications), the inkjet printing apparatus 10 that performs color printing has been adopted. However, the present invention is not limited thereto, and an inkjet printing apparatus that performs monochrome printing may be adopted. Further, in the above embodiment (including modifications), the inkjet printing apparatus 10 using an aqueous ink has been adopted. However, the present invention is not limited thereto, and an inkjet printing apparatus using ultraviolet (UV) ink (ultraviolet curing ink), such as an inkjet printing apparatus for label printing, may be adopted. In this case, an ultraviolet irradiation mechanism for curing the UV ink on the printing paper 5 by ultraviolet irradiation is provided inside the printer body 200 (cf. FIG. 1) instead of the drying mechanism 25.

Moreover, in the above embodiment (including the modification), printing is performed on the printing paper 5 by ejecting ink from the fixed print head 241 while the printing paper 5 is moved. That is, the inkjet printing apparatus 10 in one-pass system is adopted. However, the present invention is also applicable to a case where a shuttle type inkjet printing apparatus is adopted. In the shuttle type inkjet printing apparatus, after the print head moves from one end side of the printing medium such as the printing paper 5 to the other end side thereof while ejecting ink (that is, after the print head moves in the main scanning direction), the print head moves a predetermined distance in a sub-scanning direction (a direction orthogonal to the main scanning direction). Thereafter, the print head moves from the other end side of the printing medium to one end side thereof while ejecting the ink. Then, the print head moves a predetermined distance in the sub-scanning direction again.

What is claimed is:

1. A print timing signal generation method for generating a print timing signal that defines a timing at which ink is ejected from a print head in a printing apparatus including a print head configured to eject ink onto a printing medium, a moving mechanism configured to relatively move a positional relationship between the print head and the printing medium, an encoder configured to output a pulse at a cycle corresponding to a moving speed that is a speed at which the moving mechanism relatively moves the positional relationship, and an internal clock generating circuit configured to generate an internal clock at a constant cycle, the print timing signal generation method comprising:
measuring a length of each of unit periods by counting a number of internal clocks, the unit periods each being a period from a rising edge of a pulse outputted from the encoder to a next rising edge, or a period from a falling edge of a pulse outputted from the encoder to a next falling edge;
generating, based on a length of a first unit period that is a unit period one preceding, a reference signal corresponding to a signal obtained by multiplying a frequency of the print timing signal;
generating the print timing signal based on the reference signal and a multiplication setting value that is a setting value of a multiplication factor representing a relationship between the frequency of the print timing signal and a frequency of the reference signal;
calculating, based on the length of the first unit period and a length of a second unit period that is a unit period two preceding, a position deviation amount caused by a difference between the moving speed in the second unit period and the moving speed in the first unit period;
calculating a cumulative position deviation amount by accumulating the position deviation amount; and
adjusting the multiplication setting value based on a result of comparing the cumulative position deviation amount with a predetermined threshold,
wherein in the generating the print timing signal, after the print timing signal one preceding is generated, the print timing signal is generated when a number of times the reference signal is generated becomes equal to the multiplication setting value.

2. The print timing signal generation method according to claim 1, wherein in the calculating the position deviation amount, a product of a value obtained by subtracting the moving speed in the first unit period from the moving speed in the second unit period and the length of the first unit period, or a product of a value obtained by subtracting the moving speed in the second unit period from the moving speed in the first unit period and the length of the first unit period, is calculated as the position deviation amount.

3. The print timing signal generation method according to claim 2, wherein
the predetermined threshold includes a first threshold that is a negative value and a second threshold that is a positive value,
in a case where the product of the value obtained by subtracting the moving speed in the first unit period from the moving speed in the second unit period and the length of the first unit period is calculated as the position deviation amount in the calculating the position deviation amount, in the adjusting the multiplication setting value, 1 is subtracted from the multiplication setting value when the cumulative position deviation amount becomes less than the first threshold, and 1 is added to the multiplication setting value when the cumulative position deviation amount becomes greater than the second threshold, and
in a case where the product of the value obtained by subtracting the moving speed in the second unit period from the moving speed in the first unit period and the length of the first unit period is calculated as the position deviation amount in the calculating the position deviation amount, in the adjusting the multiplication setting value, 1 is added to the multiplication setting value when the cumulative position deviation amount becomes less than the first threshold, and 1 is subtracted from the multiplication setting value when the cumulative position deviation amount becomes greater than the second threshold.

4. The print timing signal generation method according to claim 2, wherein
the predetermined threshold includes a first threshold that is a negative value and a second threshold that is a positive value,
in a case where the product of the value obtained by subtracting the moving speed in the first unit period from the moving speed in the second unit period and the length of the first unit period is calculated as the position deviation amount in the calculating the position deviation amount, in the adjusting the multiplication setting value, with K regarded as a natural number, K is subtracted from the multiplication setting value when the cumulative position deviation amount becomes less than K times the first threshold, and K is added to the multiplication setting value when the cumulative position deviation amount becomes greater than K times the second threshold, and
in a case where the product of the value obtained by subtracting the moving speed in the second unit period from the moving speed in the first unit period and the length of the first unit period is calculated as the position deviation amount in the calculating the position deviation amount, in the adjusting the multiplication setting value, with K regarded as a natural number, K added to the multiplication setting value when the cumulative position deviation amount becomes less than K times the first threshold, and K is subtracted from the multiplication setting value when the cumulative position deviation amount becomes greater than K times the second threshold.

5. The print timing signal generation method according to claim 3, wherein an absolute value of the first threshold is equal to the second threshold.

6. The print timing signal generation method according to claim 1, wherein in the calculating the position deviation amount, a product of an absolute value of a difference between the moving speed in the second unit period and the moving speed in the first unit period, and the length of the first unit period, is calculated as the position deviation amount.

7. The print timing signal generation method according to claim 6, wherein
the position deviation amount, the cumulative position deviation amount, and the predetermined threshold are positive values, and
in the adjusting the multiplication setting value, when the cumulative position deviation amount becomes greater than the predetermined threshold in a case where the length of the first unit period is shorter than the length of the second unit period, 1 is subtracted from the multiplication value, and when the cumulative position deviation amount becomes greater than the predetermined threshold in a case where the length of the first unit period is longer than the length of the second unit period, 1 is added to the multiplication setting value.

8. The print timing signal generation method according to claim 6, wherein
the position deviation amount, the cumulative position deviation amount, and the predetermined threshold are positive values, and
in the adjusting the multiplication setting value, with K regarded as a natural number, when the cumulative position deviation amount becomes greater than K times the predetermined threshold in a case where the length of the first unit period is shorter than the length of the second unit period, K is subtracted from the multiplication setting value, and when the cumulative position deviation amount becomes greater than K times the predetermined threshold in a case where the length of the first unit period is longer than the length of the second unit period, K is added to the multiplication setting value.

9. The print timing signal generation method according to claim 1, wherein an absolute value of the predetermined threshold is equal to a value obtained by dividing a spacing between dots, formed on the printing medium by ejection of ink from the print head, by the multiplication setting value before being adjusted in the adjusting the multiplication setting value.

10. The print timing signal generation method according to claim 1, wherein when the print timing signal is generated in the generating the print timing signal after the multiplication setting value is changed from a reference value predetermined in advance to an adjusted value in the adjusting the multiplication setting value, the multiplication setting value is changed from the adjusted value to the reference value.

11. The print timing signal generation method according to claim 1, wherein in the generating the reference signal, P is added to a first counter value every time the internal clock is generated by the internal clock generating circuit, and when the first counter value becomes equal to or greater than a value corresponding to the length of the first unit period, a value corresponding to the length of the first unit period is subtracted from the first counter value and the reference signal is generated, the P being a number of times the reference signal is to be generated in each of the unit periods.

12. The print timing signal generation method according to claim 1, wherein in the generating the print timing signal, 1 is added to a second counter value every time the reference signal is generated in the generating the reference signal, and when the second counter value becomes equal to the multiplication setting value, the second counter value is set to 0 and the print timing signal is generated.

13. The print timing signal generation method according to claim 1, wherein, every time a pulse is outputted from the encoder, the position deviation amount is calculated in the calculating the position deviation amount, and the cumulative position deviation amount is calculated in the calculating the cumulative position deviation amount.

14. A printing apparatus comprising:
a print head configured to eject ink onto a printing medium;
a moving mechanism configured to relatively move a positional relationship between the print head and the printing medium;
an encoder configured to output a pulse at a cycle corresponding to a moving speed that is a speed at which the moving mechanism relatively moves the positional relationship;
an internal clock generating circuit configured to generate an internal clock at a constant cycle;
an encoder cycle length measuring circuit configured to measure a length of each of unit periods by counting a number of internal clocks, the unit periods each being a period from a rising edge of a pulse outputted from the encoder to a next rising edge, or a period from a falling edge of a pulse outputted from the encoder to a next falling edge;
a print timing signal generating circuit configured to generate a print timing signal that defines a timing at which ink is ejected from the print head; and
a print timing signal correcting circuit configured to correct a timing at which the print timing signal is generated,
wherein
the print timing signal generating circuit includes
a reference signal generation counter configured to generate, based on a length of a first unit period that is a unit period one preceding, a reference signal corresponding to a signal obtained by multiplying a frequency of the print timing signal, by counting a number of the internal clocks, and
a print timing signal generation counter configured to generate, by counting a number of reference signals generated by the reference signal generation counter, the print timing signal when a number of times the reference signal is generated becomes equal to a multiplication setting value that is a setting value of a multiplication factor representing a relationship between the frequency of the print timing signal and a frequency of the reference signal, after the print timing signal one preceding is generated, and
the print timing signal correcting circuit includes
a position deviation amount updating circuit configured to calculate, based on the length of the first unit period and a length of a second unit period that is a unit period two preceding, a position deviation amount caused by a difference between the moving speed in the second unit period and the moving speed in the first unit period, and calculate a cumulative position deviation amount by accumulating the position deviation amount, and
an adjustment configured to adjust the multiplication setting value referred to by the print timing signal generation counter, based on a result of comparing the cumulative position deviation amount with a predetermined threshold.

15. A non-transitory computer-readable recording medium recording a print timing signal generation program for generating a print timing signal that defines a timing at which ink is ejected from a print head in a printing apparatus including a print head configured to eject ink onto a printing medium, a moving mechanism configured to relatively move a positional relationship between the print head and the printing medium, an encoder configured to output a pulse at a cycle corresponding to a moving speed that is a speed at which the moving mechanism relatively moves the positional relationship, and an internal clock generating circuit configured to generate an internal clock at a constant cycle,
the print timing signal generation program causing a computer included in the printing apparatus to execute:
measuring a length of each of unit periods by counting a number of internal clocks, the unit periods each being a period from a rising edge of a pulse outputted from the encoder to a next rising edge, or a period from a falling edge of a pulse outputted from the encoder to a next falling edge;
generating, based on a length of a first unit period that is a unit period one preceding, a reference signal corresponding to a signal obtained by multiplying a frequency of the print timing signal;
generating the print timing signal based on the reference signal and a multiplication setting value that is a setting value of a multiplication factor representing a relationship between the frequency of the print timing signal and a frequency of the reference signal;
calculating, based on the length of the first unit period and a length of a second unit period that is a unit period two preceding, a position deviation amount caused by a difference between the moving speed in the second unit period and the moving speed in the first unit period;
calculating a cumulative position deviation amount by accumulating the position deviation amount; and
adjusting the multiplication setting value based on a result of comparing the cumulative position deviation amount with a predetermined threshold,
wherein in the generating the print timing signal, after the print timing signal one preceding is generated, the print timing signal is generated when a number of times the reference signal is generated becomes equal to the multiplication setting value.
